(19) United States
(12) Patent Application Publication
(10) Pub. No.: US 2023/0134600 A1
(43) Pub. Date: May 4, 2023

(54) METHOD AND APPARATUS FOR PROVIDING PERSONALIZED COOKING SERVICE

(71) Applicant: SAMSUNG ELECTRONICS CO., LTD., Suwon-si (KR)

(72) Inventors: Keunseob KIM, Suwon-si (KR); Kiljong KIM, Suwon-si (KR); Hongyoon KIM, Suwon-si (KR); Jongsoo YOON, Suwon-si (KR); Byunguk CHOI, Suwon-si (KR)

(73) Assignee: SAMSUNG ELECTRONICS CO., LTD., Suwon-si (KR)

(21) Appl. No.: 17/434,166

(22) PCT Filed: Jul. 20, 2021
(86) PCT No.: PCT/KR2021/009350

§ 371 Date: Aug. 26, 2021

(30) Foreign Application Priority Data
Jul. 22, 2020 (KR) 10-2020-0091261
Jan. 19, 2021 (KR) 10-2021-0007671

(51) Int. Cl. G06F 40/30; G06F 16/338

(52) U.S. Cl. CPC G06F 40/30; G06F 16/338; G06Q 50/10

(57) ABSTRACT

Provided are a server and a method for generating data for cooking food. The method may include: obtaining text indicating a food recipe; applying the text to each of a plurality of natural language understanding (NLU) models for analyzing the text; identifying a plurality of semantic elements included in the text based on at least one semantic element that is output from each of the plurality of NLU models; generating first machine readable recipe (MRR) data structured to include a plurality of cooking device control parameters, by using the plurality of semantic elements; obtaining log data of a user related to a device control action performed by the user to operate a cooking device; and generating second MRR data personalized to the user, by updating the plurality of cooking device control parameters, based on the log data.

### TECHNICAL FIELD

This application is based on and claims priority to Korean Patent Application No. 10-2020-0091261, filed on Jul. 22, 2020, in the Korean Intellectual Property Office, and Korean Patent Application No. 10-2021-0007671, filed on Jan. 19, 2021, in the Korean Intellectual Property Office, the disclosures of which are incorporated by reference herein in their entireties. The disclosure relates to a method of generating food recipe data to be readable by electrical cooking appliances as well as by users.

### BACKGROUND ART

An artificial intelligence (AI) system is a computer system that may exhibit human-level intelligence and get smarter through self-learning and making decisions, unlike an existing rule-based smart system. The more an AI system is used, the more its recognition rate improves and the more accurately it understands a user's taste, and thus, a rule-based smart system is gradually being replaced with a deep learning-based AI system.

AI technology includes machine learning (e.g., deep learning) and element technologies that use machine learning. Machine learning is an algorithm technology that self-classifies and learns characteristics of input data, and element technologies are technologies using a machine learning algorithm such as deep learning to simulate functions of the human brain such as recognition and decision-making.

Fields to which AI technology is applied include linguistic understanding for recognizing and applying/processing human languages/characters and including natural language processing, machine translation, dialog systems, questions and answering, and speech recognition/synthesis, and inference/prediction for judging information and logically inferring and predicting the same and including knowledge/probability-based reasoning, optimization prediction, preference-based planning, and recommendation.

In regard to a cooking device (e.g., a cooking appliance such as an oven) for cooking food, a user directly reads a recipe, and directly inputs a dish type, a cooking method, and setting information for cooking according to the recipe. However, it is complicated to set the cooking device according to various recipes, and dishes may not be prepared according to the recipes because the user does not know the characteristics of the cooking device well. Accordingly, there is a demand for technology for generating a recipe as standardized data to be read by a cooking device, processing the generated recipe into data personalized to a user, and providing the recipe in an intuitive form to the user.

### DESCRIPTION OF EMBODIMENTS

### Technical Problem

Various embodiments of the disclosure may provide a server for generating data for cooking food and an operating method of the server, wherein the server includes a plurality of natural language understanding (NLU) models and is capable of identifying a plurality of semantic elements in a text type recipe, generating structured data readable by various cooking devices based on the identified semantic elements, automatically setting a cooking device by using the structured data, and providing cooking information in an intuitive form to a user.

### Technical Solution to Problem

According to an aspect of the disclosure, a method performed by a server for generating data for cooking food, may include: obtaining text indicating a food recipe; applying the text to each of a plurality of natural language understanding (NLU) models for analyzing the text; identifying a plurality of semantic elements included in the text based on at least one semantic element that is output from each of the plurality of NLU models; generating first machine readable recipe (MRR) data structured to include a plurality of cooking device control parameters, by using the plurality of semantic elements; obtaining log data of a user related to a device control action performed by the user to operate a cooking device; and generating second MRR data personalized to the user, by updating the plurality of cooking device control parameters, based on the log data.

The generating of the second MRR data may include: providing, to the cooking device, control information for controlling the cooking device based on the first MRR data; obtaining compensation values for control operations of the cooking device corresponding to the control information; and generating the second MRR data by updating the plurality of cooking device control parameters based on an accumulated sum of the compensation values, wherein the compensation values may be determined based on the log data of the user.

The generating of the second MRR data may include: while the cooking device operates according to the control information for controlling the cooking device, receiving, from the cooking device, input data indicating the device control action of the user; obtaining evaluation data of the user on the food cooked by an operation of the cooking device; and allocating the received input data of the user and the evaluation data of the user to the compensation values.

The method may further include: generating a plurality of first recipe cards for cooking the food by using the first MRR data; and providing the plurality of first recipe cards to a client device.

The method may further include: generating a plurality of second recipe cards for cooking the food personalized to the user by using the second MRR data; and providing the plurality of second recipe cards to the client device.

The method may further include determining the plurality of NLU models, based on a type of the food.

The method may further include determining cooking steps for cooking the food by using the plurality of semantic elements, wherein the generating of the plurality of first recipe cards may include determining a type of the plurality of first recipe cards, based on the first MRR data and the determined cooking steps, wherein the type of the plurality of first recipe cards may include at least one of a cooking device control type, a cooking item purchase type, or a cooking information provision type.

The method may further include: changing at least part of the first MRR data and the second MRR data, so that the food is cooked by another cooking device, based on identification information of the other cooking device.

The method may further include: receiving characteristic information about characteristics of the food input by the user from a client device; and changing at least part of the first MRR data and the second MRR data, based on the received characteristic information.

The method may further include: changing at least part of the first MRR data and the second MRR data, based on food ingredient information of the food

According to an aspect of the disclosure, a server for generating data for cooking food may include: a communication interface; a memory storing one or more instructions; and a processor configured to execute the one or more instructions stored in the memory to obtain text indicating a food recipe; apply the text to each of a plurality of natural language understanding (NLU) models for analyzing the text; identify a plurality of semantic elements included in the text, based on at least one semantic element that is output from each of the plurality of NLU models; generate first machine readable recipe (MRR) data structured to include a plurality of cooking device control parameters, by using the plurality of semantic elements; obtain log data of a user related to device control action performed by the user to operate a cooking device; and generate second MRR data personalized to the user by updating the plurality of cooking device control parameters, based on the log data.

The processor may be further configured to execute the one or more instructions to provide, to the cooking device, control information for controlling the cooking device based on the first MRR data, obtain compensation values for control operations of the cooking device corresponding to the control information, and generate the second MRR data by updating the plurality of cooking device control parameters based on an accumulated sum of the compensation values. The compensation values may be determined based on the log data of the user.

The processor may be further configured to execute the one or more instructions to, while the cooking device operates according to the control information for controlling the cooking device, receive, from the cooking device, input data indicating the device control action of the user, obtain evaluation data of the user on the food cooked by an operation of the cooking device, and allocate the received input data of the user and the evaluation data of the user to the compensation values.

The processor may be further configured to execute the one or more instructions to generate a plurality of first recipe cards for cooking the food by using the first MRR data, and provide the plurality of first recipe cards to a client device.

The processor may be further configured to execute the one or more instructions to generate a plurality of second recipe cards for cooking the food personalized to the user by using the generated second MRR data, and provide the plurality of second recipe cards to the client device.

The processor may be further configured to execute the one or more instructions to determine the plurality of NLU models, based on a type of the food.

The processor is further configured to execute the one or more instructions to determine cooking steps for cooking the food by using the plurality of semantic elements, determine a type of the plurality of first recipe cards, based on the first MRR data and the cooking steps, wherein the type of the plurality of first recipe cards may include at least one of a cooking device control type, a cooking item purchase type, or a cooking information provision type.

The processor may be further configured to execute the one or more instructions to change at least part of the first MRR data and the second MRR data, so that the food is cooked by another cooking device, based on identification information of the other cooking device.

The processor may be further configured to execute the one or more instructions to receive characteristic information about characteristics of the food input by the user from a client device, and change at least part of the first MRR data and the second MRR data, based on the received characteristic information.

According to an embodiment of the present disclosure, there is provided a non-transitory computer-readable recording medium having recorded thereon a program for executing the method for generating the data for cooking the food.

According to an aspect of the disclosure, a method for generating data for a cooking process, the method including: obtaining a food recipe in a text form, to perform the cooking process; based on a plurality of semantic elements identified from the food recipe, generating first machine readable recipe (MRR) data including a plurality of cooking device control parameters; transmitting the first MRR data to an electric cooking appliance to operate the electric cooking appliance based on the plurality of cooking device control parameters; obtaining information of at least one user control action that is applied to the electric cooking appliance during the cooking process; generating second MRR by updating the plurality of cooking device control parameters of the first MRR data based on the information of the at least one user control action; and transmitting the second MRR to the electrical cooking appliance to operate the electric cooking appliance based on the updated plurality of cooking device control parameters.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram for describing a method performed by a server for providing food cooking information and controlling cooking devices, according to an embodiment of the disclosure.

FIG. 2 is a block diagram illustrating detailed elements of the server, according to an embodiment of the disclosure.

FIG. 3 is a flowchart illustrating a method performed by a server for generating first machine readable recipe (MRR) data and second MRR data, according to an embodiment of the disclosure.

FIG. 4 is a diagram for describing operations of a recipe syntax analysis module included in a server, according to an embodiment of the disclosure.

FIG. 5 is a diagram for describing a method performed by a server for identifying semantic elements with a plurality of natural language understanding (NLU) models, by using a recipe syntax analysis module, according to an embodiment of the disclosure.

FIG. 6 is a diagram for describing detailed elements of an additional information generation module for generating additional information based on identified semantic elements, included in a server, according to an embodiment of the disclosure.

FIG. 7 is a diagram for describing a method performed by a server for generating first MRR data by using semantic elements identified from a plurality of NLU models, according to an embodiment of the disclosure.

FIG. 8 is a diagram for describing a method performed by a server for identifying semantic elements from text indicating a recipe by using a first MRR data generation module, generating cooking device control parameters, and thus generating first MRR data so that the recipe is readable by a cooking device, according to an embodiment of the disclosure.

FIG. 9 is a diagram for describing a method performed by a server for obtaining log data of a user and generating second MRR data based on the obtained log data, according to an embodiment of the disclosure.

FIG. 10 is a diagram for describing an embodiment where a server performs reinforcement learning based on log data of a user when second MRR data is generated, according to an embodiment of the disclosure.

FIG. 11 is a diagram for describing a method performed by a server for generating a recipe card, according to an embodiment of the disclosure.

FIG. 12 is a diagram for describing a method performed by a server for generating a recipe card for each cooking step, according to an embodiment of the disclosure.

FIG. 13 is a diagram for describing a method performed by a server for changing and optimizing generated MRR data according to a cooking device of a user, according to an embodiment of the disclosure.

FIG. 14 is a diagram for describing a method performed by a server for changing and optimizing generated MRR data based on various user information, according to an embodiment of the disclosure.

FIG. 15 is a diagram for describing elements of a cooking information providing system, according to an embodiment of the disclosure.

FIG. 16 is a diagram for describing an example where a server generates MRR data and recipe cards and then information for food cooking is provided to a user through a client device, according to an embodiment of the disclosure.

FIG. 17 is a diagram illustrating a graphical user interface (GUI) for generating MRR data for a new recipe by using previously generated multiple MRR data, in a cooking information providing system, according to an embodiment of the disclosure.

FIG. 18 is a diagram for describing an example where recipe cards for cooking a plurality of foods are provided to a user through a client device, in a cooking information providing system, according to an embodiment of the disclosure.

FIG. 19 is a diagram for describing an example where a first recipe card and a personalized second recipe card are provided to a user through a client device, in a cooking information providing system, according to an embodiment of the disclosure.

### MODE OF DISCLOSURE

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Throughout the disclosure, the expression “at least one of a, b or c” indicates only a, only b, only c, both a and b, both a and c, both b and c, all of a, b, and c, or variations thereof.

The terms used herein will be briefly described, and the disclosure will be described in detail.

The terms used herein are those general terms currently widely used in the art in consideration of functions in the disclosure but the terms may vary according to the intention of one of ordinary skill in the art, precedents, or new technology in the art. Also, some of the terms used herein may be arbitrarily chosen by the present applicant, and in this case, these terms are defined in detail below. Accordingly, the specific terms used herein should be defined based on the unique meanings thereof and the whole context of the disclosure.

It is to be understood that the singular forms “a,” “an,” and “the” include plural referents unless the context clearly dictates otherwise. The terms including technical and scientific terms used herein have the same meaning as commonly understood by one of ordinary skill in the art to which the disclosure belongs. Terms such as “first” and “second” may be used to describe various components but the components should not be limited by the terms. These terms are only used to distinguish one component from another.

It will be understood that when a certain part “includes” a certain component, the part does not exclude another component but may further include another component, unless the context clearly dictates otherwise. Also, the term used in the specification such as “˜unit” or “˜module” indicates a unit for processing at least one function or operation, and may be implemented in hardware, software, or in a combination of hardware and software.

The disclosure will now be described more fully with reference to the accompanying drawings for one of ordinary skill in the art to be able to perform the disclosure without any difficulty. However, the disclosure may be embodied in many different forms and is not limited to the embodiments of the disclosure set forth herein. For clarity, parts not related to explaining the disclosure are omitted in the drawings and like components are denoted by like reference numerals throughout the specification.

In an embodiment of the disclosure, natural language understanding (NLU) model may be an artificial intelligence (AI) model trained to interpret text and obtain semantic elements in the text. In this case, the AI model may include a plurality of neural network layers. The plurality of neural network layers may respectively include a plurality of weights, and may perform a neural network operation through an operation between the plurality of weights and an operation result of a previous layer.

In an embodiment of the disclosure, machine readable recipe (MRR) data may be structured data generated from text indicating a recipe that is unstructured data, and may be structured data that is converted to be readable by a cooking device. A server according to an embodiment of the disclosure may control various types of different cooking devices by using structured MRR data. MRR data according to an embodiment of the disclosure may include cooking device control parameters generated from identified semantic elements, and the cooking device control parameters may be parameters related to a control operation of a cooking device. A server may control various types of different cooking devices to cook food in a cooking device, by using cooking device control parameters in MRR data. Also, MRR data may include first MRR data and second MRR data.

In an embodiment of the disclosure, first MRR data may be generated by using semantic elements identified by using a plurality of NLU models from text indicating a recipe, and various cooking devices may read structured text type MRR data and may perform a cooking operation by applying the MRR data to a cooking step.

In an embodiment of the disclosure, second MRR data refers to MRR data generated based on first MRR data and user log data. Second MRR data may be data obtained by updating cooking device control parameters in first MRR data, so that food is cooked reflecting a user's personal cooking tendency or the like.

In an embodiment of the disclosure, a recipe card may be card type data that intuitively provides information required in each cooking step to a user who is to cook food. A recipe card may correspond to each of cooking steps constituting a recipe, and may provide various functions related to cooking and information related to cooking to a user.

In an embodiment of the disclosure, log data of a user may be data related to an device control action performed by the user to operate a cooking device. Log data of a user may include a temperature, a cooking time, and the number of cookings of a cooking device manipulated by the user, and may include food evaluation data input by the user for a completed dish.

In an embodiment of the disclosure, additional information may be additional information generated to guide a cooking process, based on semantic elements identified by using a plurality of NLU models, in text indicating an input recipe. For example, additional information may include taste information that is changed when a cooking time in a specific cooking step is changed, based on a semantic element related to a cooking time identified in text indicating a recipe. Generated additional information may be included in a recipe card when the recipe card is generated and may be provided to a user, or may be inserted into MRR data and may be stored in the MRR data.

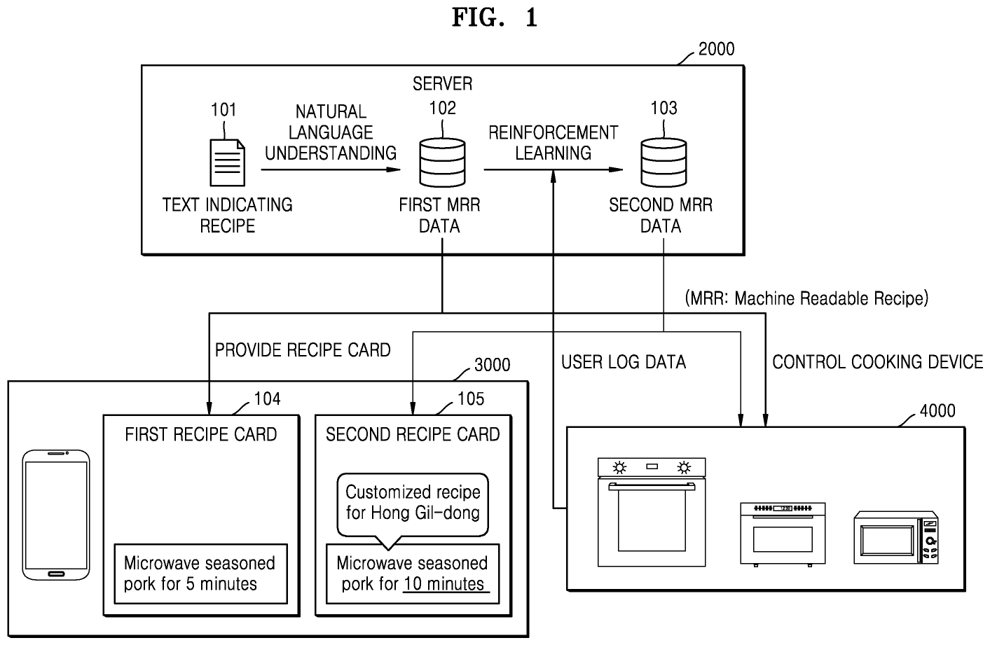

FIG. 1 is a diagram for describing a method performed by a server for providing food cooking information and controlling cooking devices, according to an embodiment of the disclosure.

A server 2000 according to an embodiment of the disclosure may obtain text 101 indicating a food recipe, identify semantic elements in the text by using a plurality of natural language understanding (NLU) models, generate first machine readable recipe (MRR) data 102 applicable to various cooking devices 4000, and generate additional information for guiding cooking. In particular, the text 101 indicating the food recipe may be received from a client device 3000, but the disclosure is not limited thereto. The text 101 indicating the food recipe may be received from another external device (e.g., a third party server) or may be pre-stored in a storage of the server.

Also, the server 2000 according to an embodiment of the disclosure may obtain log data of a user for the cooking devices 4000, and may generate second MRR data 103 including a cooking method personalized to the user by updating the first MRR data 102 based on the obtained log data.

The server 2000 according to an embodiment of the disclosure may generate a plurality of first recipe cards 104 for cooking food by using the first MRR data 102 and the additional information, and may provide the generated plurality of first recipe cards 104 to the client device 3000.

Also, the server 2000 according to an embodiment of the disclosure may generate a plurality of second recipe cards 105 for cooking food personalized to the user, by using the second MRR data 103 and the additional information, and may provide the generated plurality of second recipe cards 105 to the client device 3000. Also, when the cooking devices 4000 may include a display or a speaker that is configured to provide information in the first recipe cards 104 or the second recipe cards 105 in a visual or acoustic form, the server 2000 may provide the generated first recipe cards 104 or second recipe cards 105 to the cooking devices 4000.

The client device 3000 may receive a control command of the cooking devices 4000 from the user, and may transmit control requests of the cooking devices 4000 to the server 2000. In response to the received control requests, the server 2000 may change the first MRR data or the second MRR data into instructions executable by each cooking device 4000 according to an interface of each cooking device 4000, and may transmit instructions for controlling each cooking device 4000 to each cooking device 4000.

The cooking device 4000 may perform a cooking operation, based on control information for controlling the cooking device received from the server 2000.

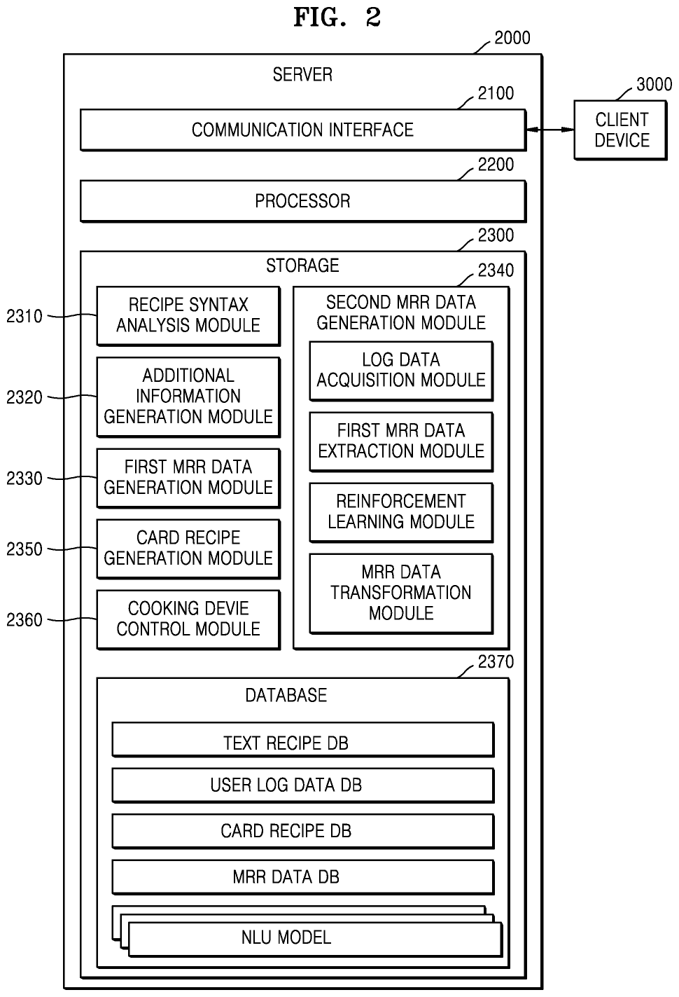

FIG. 2 is a block diagram illustrating detailed elements of a server, according to an embodiment of the disclosure.

The server 2000 according to an embodiment of the disclosure may include at least a communication interface 2100, a processor 2200, and a storage 2300.

The communication interface 2100 may transmit and receive data or a signal to and from an external device (e.g., the client device 3000, a model server, a processing server, or a cooking device under the control of the processor 2200.

The communication interface 2100 may transmit and receive data or a signal to and from an external device (e.g., the client device 3000, a third party server, or a cooking device) under the control of the processor 2200.

The communication interface 2100 according to an embodiment of the disclosure may include at least one element for enabling communication through a local area network (LAN), a wide area network (WAN), a value-added network (VAN), a mobile radio communication network, a satellite communication network, or a combination thereof.

The communication interface 2100 according to an embodiment of the disclosure may receive text indicating a recipe from the client device 3000. Also, the communication interface 2100 may receive a cooking device control command from the client device 3000 in order to control a cooking device, and may transmit cooking device control instructions generated based on MRR data to cooking devices.

The processor 2200 may generally control the server 2000. The processor 2200 may execute one or more instructions of a program stored in a memory (e.g., the storage 2300). The processor 2200 may include a hardware element for performing arithmetic, logic, and input/output operations and signal processing.

The processor 2200 according to an embodiment of the disclosure may include at least one of, for example, but not limited to, a central processing unit, a microprocessor, a graphics processing unit, an application-specific integrated circuit (ASIC), a digital signal processor (DSP), a digital signal processing device (DSPD), a programmable logic device (PLD), a field-programmable gate array (FPGA), an application processor (AP), a neural processing unit, or a dedicated AI processor (e.g., an AI accelerator or a machine learning accelerator) designed with a hardware structure specialized for processing an AI model.

The storage 2300 may store instructions, data structures, and program codes readable by the processor 2200. In disclosed embodiments of the disclosure, operations performed by the processor 2200 may be implemented by executing instructions or codes of a program stored in the storage 2300.

The storage 2300 may include a non-volatile memory including at least one of a flash memory type, a hard disk type, a multimedia card micro type, a card type memory (e.g., SD or XD memory), a read-only memory (ROM), an electrically erasable programmable read-only memory (EPPROM), a programmable read-only memory (PROM), a magnetic memory, a magnetic disk, and an optical disk, and a volatile memory such as a random-access memory (RAM) or a static random-access memory (SRAM).

The storage 2300 may store instructions, data structures, and program codes readable by the processor 2200. In disclosed embodiments of the disclosure, operations performed by the processor 2200 may be implemented by executing instructions or codes of a program stored in the storage 2300. In an embodiment of the disclosure, the storage 2300 may store data and program instruction codes corresponding to a recipe syntax analysis module 2310, an additional information generation module 2320, a first MRR data generation module 2330, a second MRR data generation module 2340, a card recipe generation module 2350, a cooking device control module 2360, and a database 2370.

In an embodiment of the disclosure, the database 2370 may include a text recipe, NLU models, user log data, a card recipe, and MRR data.

The processor 2200 according to an embodiment of the disclosure may generate first MRR data by receiving a text indicating a recipe and loading and executing a plurality of NLU models stored in the storage 2300 to perform syntax analysis on the text indicating the recipe. Also, the processor 2200 may obtain log data of a user related to a device control action performed by the user to operate or manipulate a cooking device, and may generate second MRR data personalized to the user based on the log data of the user and the first MRR data.

The processor 2200 according to an embodiment of the disclosure may execute the plurality of NLU models by using the recipe syntax analysis module 2310 stored in the storage 2300, and may identify semantic elements as recognition targets (e.g., a cooking tool and ingredients) according to the NLU models. For example, the processor 2200 may obtain text indicating a recipe, may apply the text to each of a plurality of NLU models, and may identify one or more semantic elements output from each of the plurality of NLU models.

The processor 2200 according to an embodiment of the disclosure may generate additional information for guiding cooking, by using the additional information generation module 2320 stored in the storage 2300. For example, the processor 2200 may convert, based on semantic elements identified by the recipe syntax analysis module 2310, a time-related expression from among the identified semantic elements into a numerical form, and may generate additional information for guiding taste information that varies when a cooking time applied for each cooking step increases or decreases. In another embodiment of the disclosure, the processor 2200 may identify an amount-related expression from among the identified semantic elements, and may generate additional information for guiding taste information that varies when the amount of cooking ingredients applied for each cooking step increases or decreases. In another embodiment of the disclosure, the processor 2200 may identify a temperature-related expression from among the identified semantic elements, and may generate additional information for guiding taste information that varies when a cooking temperature for each cooking step increases or decreases. Also, the processor 2200 may identify an item such as cooking ingredients, a cooking tool, or a cooking device from the semantic elements identified by the recipe syntax analysis module 2310 by using the additional information generation module 2320, and may search for advertisement information related to the identified item. Also, the processor 2200 may identify an expression related to a cooking technique, a plating method, a cooking tool, or cooking ingredients from among the semantic elements identified by the recipe syntax analysis module 2310 by using the additional information generation module 2320, and may search for media content such as a video, an image, or an audio related to the identified expression.

The processor 2200 according to an embodiment of the disclosure may generate first MRR data structured to include a plurality of cooking device control parameters, by using the first MRR generation module 2330 stored in the storage 2300. For example, the processor 2200 may generate entity data corresponding to semantic elements identified by the recipe syntax analysis module 2310 by using the first MRR generation module 2330, and may generate first MRR data by inserting the generated cooking device control parameters into a format of the structured first MRR data.

The processor 2200 according to an embodiment of the disclosure may change first MRR data and may generate second MRR data personalized to the user, by using the second MRR generation module 2340 stored in the storage. The second MRR data generation module 2340 may include a log data acquisition module, a first MRR data extraction module, a reinforcement learning module, and an MRR data transformation module.

The processor 2200 may obtain log data related to device control actions performed by the user to operate or manipulate a cooking device by using the log data acquisition module, and may extract cooking device control parameters corresponding to the log data in first MRR data by using the first MRR data extraction module. The processor 2200 may generate second MRR data by updating the cooking device control parameters in the first MRR data based on the obtained log data, by using the MRR data transformation module.

Also, the processor 2200 may execute the reinforcement learning module in the second MRR generation module 2340, to perform reinforcement learning based on feedbacks on device control actions that are performed by the user to operate cooking devices. In particular, log data of the user may be used when the reinforcement learning is performed. The processor 2200 may generate second MRR data personalized to the user by changing first MRR data based on a result output from the reinforcement learning module, by using the MRR data transformation module.

The processor 2200 according to an embodiment of the disclosure may generate a plurality of first recipe cards for providing information for food cooking based on generated first MRR data and generated additional information, by using the card recipe generation module 2350 stored in the storage 2300. Also, the processor 2200 may generate a plurality of second recipe cards for food cooking personalized to the user based on generated second MRR data and generated additional information.

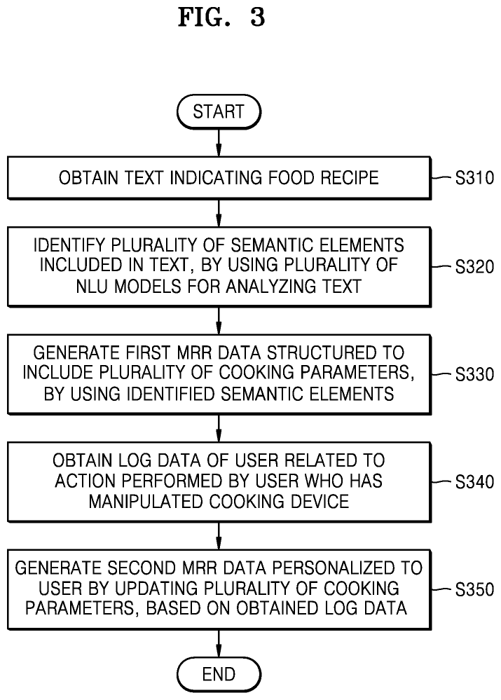

FIG. 3 is a flowchart illustrating a method performed by a server for performing an operation to generate first MRR data and second MRR data, according to an embodiment of the disclosure.

In operation S310, the server 2000 may obtain text indicating a food recipe. The ‘text indicating the recipe’ refers to text type data indicating a recipe for cooking food, which may be obtained by using various methods.

For example, the text indicating the recipe may be obtained from a recipe including text in a computer-usable document format, a recipe page on the Web, or text extracted from an image of a recipe including the text, but the disclosure is not limited thereto. Also, the text indicating the recipe is not necessarily obtained from text, but may be obtained from other types of data such as an image or a video. For example, when a recipe including an image or the like is received, the server 2000 may identify only a text part in the recipe and may use the text part to generate data for cooking.

In operation S320, the server 2000 may identify a plurality of semantic elements included in the text, by using a plurality of NLU models for analyzing the text. In particular, the server 2000 may determine a plurality of NLU models for performing syntax analysis on the text. In an embodiment of the disclosure, the server 2000 may determine a plurality of NLU models to be used for syntax analysis based on a type of food indicated by the obtained text, and may identify semantic elements by using the determined NLU models. Each of the NLU models may be a model trained to recognize and extract semantic elements of a specific category.

However, the disclosure is not limited thereto, and the server 2000 may identify semantic elements by using a plurality of NLU model that are previously determined, without determining a plurality of NLU model to be used for syntax analysis for the obtained text.

When a plurality of NLU models are determined to perform syntax analysis on the obtained text and the number of semantic elements of a specific category to be identified is equal to or greater than a preset number, the server 2000 according to an embodiment of the disclosure may allocate priorities to the plurality of NLU models, may determine the plurality of NLU models based on the allocated priorities, and may identify semantic elements in the obtained text.

The server 2000 according to an embodiment of the disclosure may apply the obtained text to the plurality of NLU models sequentially or in parallel, and may obtain a semantic element to be identified by each NLU model by performing text analysis for each NLU model.

For example, the server 2000 may obtain a ‘first semantic element’ that is at least one semantic element output by applying the obtained text to a first NLU model, and a ‘second semantic element’ that is at least one semantic element output by applying the obtained text to a second NLU model. The server 2000 may obtain an ‘Nth semantic element’ that is at least one semantic element output by applying the text to an Nth NLU model in the same manner.

In operation S330, the server 2000 according to an embodiment of the disclosure may generate first MRR data that is structured data based on the identified semantic elements. For example, the first MRR data may be structured text data that is written in a JavaScript Object Notation format, but the disclosure is not limited thereto. The first MRR data may be structured text data that is implemented in another programming language.

The first MRR data according to an embodiment of the disclosure may include cooking device control parameters. The cooking device control parameters may be parameters indicating a control operation of a cooking device. The cooking device control parameters may include an operation mode, an operation temperature, and an operation time of the cooking device. For example, in the case of a recipe for oven cooking, the cooking device control parameters in the first MRR data may include convection mode, 200° C., and 20 minutes.

Also, the first MRR data may include basic recipe information and cooking step information. The basic recipe information may include a dish name, a dish type, a recipe generation date, a recipe version, a cooking time, a recipe author, and cooking ingredients. The cooking step information may include information such as an original sentence of the text indicating the recipe, a cooking behavior of the user required for each step, an device control action of the user related to the cooking device, media content corresponding to the recipe, cooking ingredients required for each cooking step, and a cooking tool required for each cooking step.

In operation S340, the server 2000 according to an embodiment of the disclosure may obtain log data of the user related to device control actions performed by the user to operate the cooking device. For example, the log data may be related to device control actions performed by the user to operate the cooking device during a certain period of time.

In an embodiment of the disclosure, the log data of the user may include parameters related to a control operation of the cooking device such as an operation temperature, an operation time, and the number of operations of the cooking device, and may include evaluation data of the user on cooking, but the disclosure is not limited thereto.

The log data of the user according to an embodiment of the disclosure may be received by the server 2000 from the cooking device, may be received by another external device (e.g., a third party server) from the cooking device, or may be received by the server 2000 from another external device.

In an embodiment of the disclosure, the log data of the user may be log data of the user obtained by recording data related to device control actions performed by the user to operate the cooking device.

In another embodiment of the disclosure, the log data of the user may be log data of the user related to a device control action additionally performed by the user to operate the cooking device, different from the cooking device control parameters included in the first MRR data. For example, when the cooking device control parameters included in the first MRR data include convection mode of oven, 200° C., and 20 minutes and the user additionally has been manipulated an oven to cook in a convection mode at 200° C. for 5 minutes, the log data of the user may include convention mode, 200° C., and 5 minutes.

In operation S350, the server 2000 according to an embodiment of the disclosure may generate second MRR data personalized to the user by updating the plurality of cooking device control parameters included in the first MRR, based on the obtained log data of the user.

When it is determined based on the log data of the user that the number of times the user operates the cooking device in a specific mode of the cooking device is equal to or greater than a certain number of times, the server 2000 according to an embodiment of the disclosure may update the plurality of cooking device control parameters included in the first MRR data to values corresponding to the log data of the user.

For example, when the user cooks pork, the cooking device may complete a pork dish by performing cooking operations based on the first MRR data. In particular, the user of the cooking device may further cook by additionally manipulating the cooking device (e.g., heating at 200° C. for another 5 minutes) to suit the user's preference, and the log data of the user may be generated according to the user's manipulation of the cooking device.

The server 2000 according to an embodiment of the disclosure may generate the second MRR data indicating a recipe personalized to the user, by changing the cooking device control parameters included in the first MRR data (e.g., by changing ‘convection mode, 200° C., and 20 minutes’ into ‘convection mode, 200° C., and 25 minutes), based on the log data of the user.

Also, the server 2000 may generate the second MRR data by using reinforcement learning.

The server 2000 may generate the second MRR data by performing reinforcement learning, by using a reinforcement learning module. In particular, the server 2000 may allocate values included in the log data of the user to compensation values. While the cooking device is operating, the server 2000 may obtain compensation values corresponding to operations of the cooking device in each cooking step, may update the cooking device control parameters in the first MRR data so that an accumulated sum of the compensation values obtained till a cooking completion step is maximized, and thus may generate the second MRR data indicating the recipe personalized to the user.

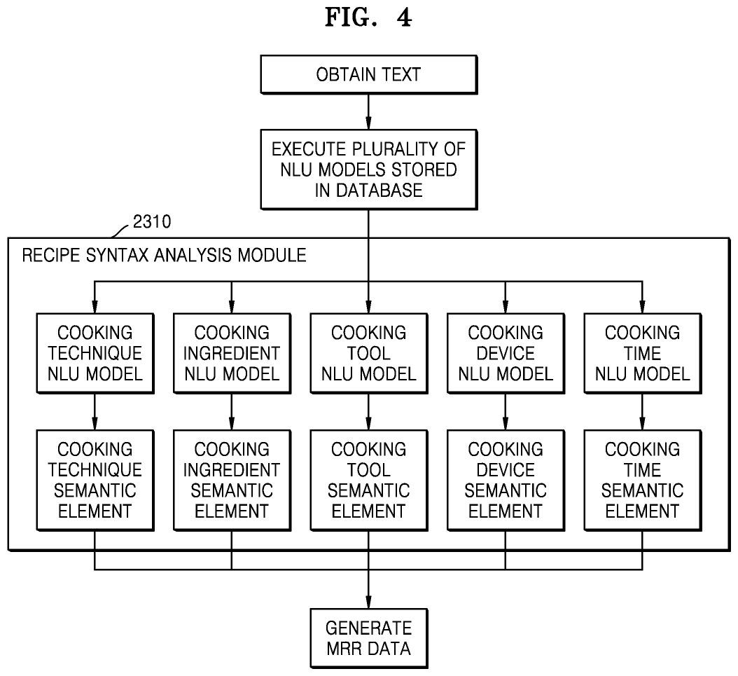

FIG. 4 is a diagram for describing operations of a recipe syntax analysis module included in a server, according to an embodiment of the disclosure.

In an embodiment of the disclosure, semantic elements refer to data related to cooking of food, recognized through an NLU model in text indicating a recipe. Semantic elements identified by using an NLU model may be classified according to categories that are preset for food cooking. For example, the semantic elements may be classified according to categories such as a cooking device, a cooking technique, cooking ingredients, a cooking tool, a cooking time, and a cooking amount. When the semantic elements according to an embodiment of the disclosure are changed, a cooking result of food cooked by a cooking device may be changed.

Also, the server 2000 may identify intent information determined to indicate the intent of text from the semantic elements. For example, when the input text is ‘make a sauce by mixing 3 spoons of minced garlic, 2 spoons of soy sauce 2, 2 spoons of oyster sauce, 3 spoons of oligosaccharide, and 1 spoon of melted butter.’The intent may be ‘source preparation’. When the server 2000 generates additional information to guide a cooking process based on the identified semantic elements, the server 2000 may generate the additional information by using the identified intent information.

Referring to FIG. 4, the server 2000 may obtain text indicating a recipe. The text indicating the recipe may include various information related to a cooking method such as a cooking technique, cooking ingredients, a cooking tool, a cooking device, and a cooking time. The server 2000 may determine a plurality of NLU models for syntax analysis, in order to extract semantic elements in the obtained text. In particular, each NLU model may be an NLU model trained to identify a semantic element corresponding to a specific category, and the determined NLU models may independently perform text recognition for the obtained text and may identify a plurality of semantic element output from each NLU model.

However, the disclosure is not limited thereto, and the server 2000 may identify semantic elements by using a plurality of NLU models that are previously determined, without determining a plurality of NLU models to be used for syntax analysis.

In an embodiment of the disclosure, the server 2000 may identify a cooking technique semantic element by using a cooking technique NLU model, may identify a cooking ingredient semantic element by using a cooking ingredient NLU model, may identify a cooking tool semantic element by using a cooking tool NLU model, may identify a cooking device semantic element by using a cooking device NLU model, and may identify a cooking time semantic element by using a cooking time NLU model, in the obtained text.

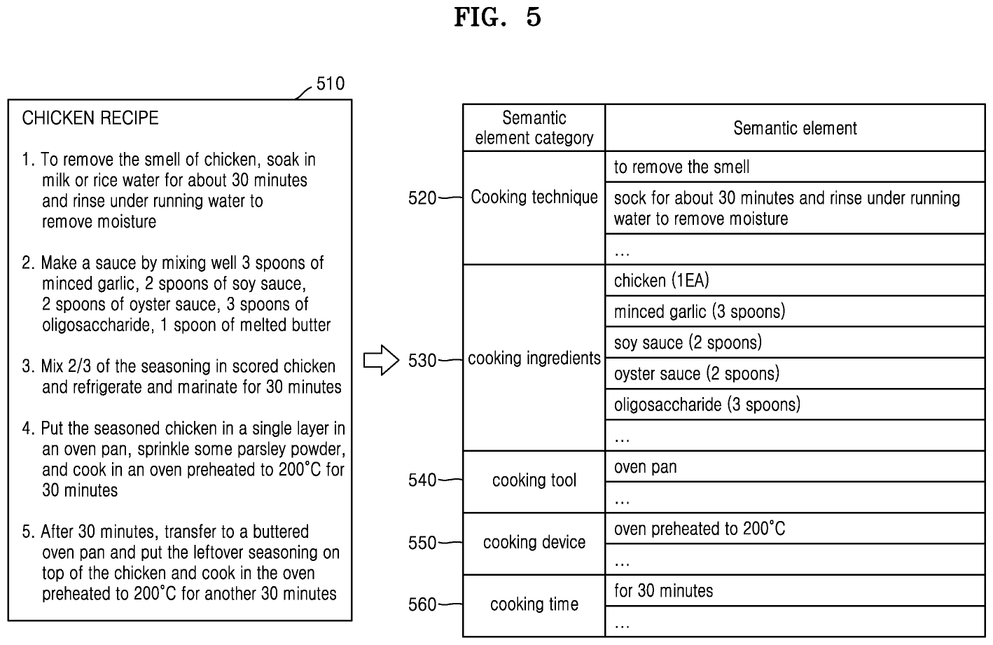

A specific embodiment in which the server 2000 identifies semantic elements according to categories in obtained text will be further described with reference to FIG. 5.

FIG. 5 is a diagram for describing a method performed by a server for identifying semantic elements with a plurality of NLU models, by using a recipe syntax analysis module, according to an embodiment of the disclosure.

In an embodiment of the disclosure, the server 2000 may obtain text indicating a recipe for various foods. The following will be described assuming that the text indicating the recipe obtained by the server 2000 is text indicating ‘chicken recipe’.

For obtained text 510 indicating a ‘chicken recipe,’ the server 2000 may determine that a plurality of NLU models to be used for analyze the text are a cooking technique NLU model, a cooking ingredient NLU model, a cooking tool NLU model, a cooking device NLU model, and a cooking time NLU model, from among a plurality of NLU models stored in a storage. The server 2000 may identify semantic elements according to categories corresponding to respective NLU models, by using the determined NLU models.

For example, the server 2000 may identify at least one semantic element related to a cooking technique, by applying the text 510 indicating the ‘chicken recipe’ to the cooking technique NLU model. In detail, the server 2000 may identify, from the text 510 indicating the chicken recipe, cooking technique semantic elements 520 that may change a cooking result according to a cooking technique of a user in a cooking process such as ‘to remove the smell,’ soak for about 30 minutes and rinse under running water to remove moisture,′ make a sauce by mixing well,′ sheathed chicken,′ ‘mix ⅔ of the seasoning,’ and ‘marinate for 30 minutes’.

In another embodiment of the disclosure, the server 2000 may identify at least one semantic element related to cooking ingredients, by applying the text 510 indicating the ‘chicken recipe’ to the cooking ingredient NLU model. In detail, the server 2000 may identify, from the text 510 indicating the chicken recipe, cooking ingredient semantic elements 530 that may change a cooking result according to cooking ingredients in a cooking process such as ‘chicken,’ ‘milk or rice water,’ ‘3 spoons of minced garlic,’ ‘2 spoons of soy sauce,’ ‘2 spoons of oyster sauce,’ ‘3 spoons of oligosaccharide,’ ‘1 spoon of melted butter,’ and ‘parsley powder’.

In another embodiment of the disclosure, the server 2000 may identify at least one semantic element related to a cooking tool, by applying the text 510 indicating the ‘chicken recipe’ to the cooking tool NLU model. In detail, the server 2000 may identify, from the text 510 indicating the chicken recipe, cooking tool semantic elements 540 that may change a cooking result according to a cooking tool, such as ‘oven pan’.

In the same manner, the server 2000 may identify cooking device semantic elements 550 and cooking time semantic elements 560 output according to models, by respectively applying the text 510 indicating the ‘chicken recipe’ to the cooking device NLU model and the cooking time NLU model.

The server 2000 according to an embodiment of the disclosure may generate first MRR data and additional information, by using semantic elements obtained according to categories by applying each NLU model to text indicating a recipe.

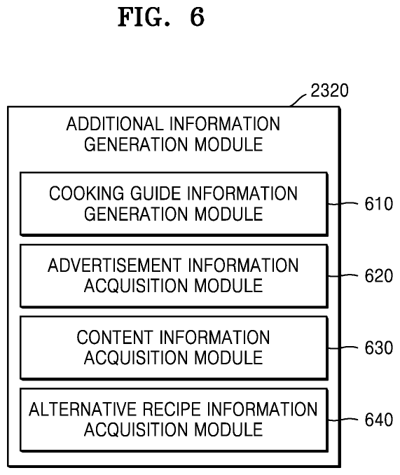

FIG. 6 is a diagram for describing detailed elements of an additional information generation module for generating additional information based on identified semantic elements, included in a server, according to an embodiment of the disclosure.

The server 2000 according to an embodiment of the disclosure may generate additional information for guiding food cooking, by using the additional information generation module 2320. In particular, the additional information generation module 2320 may include a cooking guide information generation module 610, an advertisement information acquisition module 620, a content information acquisition module 630, and an alternative recipe information acquisition module 640.

In an embodiment of the disclosure, the server 2000 may generate cooking guide information, based on semantic elements identified in text indicating a recipe.

For example, the server 2000 may convert a time-related expression from among the identified semantic elements into a numerical form by using the cooking guide information generation module 610, and may generate additional information for guiding taste information that varies when a cooking time applied for each cooking step increases or decreases. In another example, the server 2000 may identify an amount-related expression from among the identified semantic elements, and may generate additional information for guiding taste information that varies when the amount of cooking ingredients applied for each cooking step increases or decreases. In another embodiment of the disclosure, the server 2000 may identify a temperature-related expression from among the identified semantic elements, and may generate additional information for guiding taste information that varies when a cooking temperature for each cooking step increases or decreases.

In an embodiment of the disclosure, the server 2000 may obtain advertisement information, based on the semantic elements identified in the test indicating the recipe.

For example, the server 2000 may identify an item such as cooking ingredients, a cooking tool, or a cooking device from the identified semantic elements, and may search for advertisement information related to the identified item, by using the advertisement information acquisition module 620. Also, the server 2000 may identify an item such as cooking ingredients, a cooking tool, or a cooking device from MRR data, and may search for advertisement information related to the identified item, by using the advertisement information acquisition module 620. The advertisement information acquisition module 620 may match the searched advertisement information to a corresponding semantic element and may generate additional information capable of providing advertisement information for each cooking step.

In an embodiment of the disclosure, the server 2000 may obtain content information based on the semantic elements identified in the text indicating the recipe.

For example, the server 2000 may identify an expression related to a cooking technique, a plating method, a cooking tool, or cooking ingredients from among the identified semantic elements, by using the content information acquisition module 630. The server 2000 may search for media content such as a video, an image, or an audio related to the identified expression, by using the content information acquisition module 630. The server 2000 may match the searched content to a corresponding semantic element and may generate additional information capable of providing media content for each cooking step.

In an embodiment of the disclosure, the server 2000 may obtain alternative recipe information based on the semantic elements identified in the text indicating the recipe and user profile information obtained from a user.

For example, the server 2000 may search for a cooking method other than a cooking method written in the currently identified recipe, based on identified recipe information and user profile information (e.g., a cooking device owned by the user and taste preference of the user), by using the alternative recipe information acquisition module 640. The server 2000 may generate, as additional information, a recipe obtained by modifying at least a part of the current recipe or a recipe replacing the current recipe, based on the searched cooking method.

Although an embodiment of generating additional information for guiding cooking has been described with reference to FIG. 6, this is merely an example for convenience of explanation, and various additional information modules for guiding cooking in addition to the above-described addition information may be included.

When the server 2000 according to an embodiment of the disclosure generates a recipe card by using a card recipe generation module 2350, the server 2000 may generate the recipe card in which additional information corresponding to each cooking step is included. The server 2000 may provide the recipe card including the additional information to the user. Also, when the server 2000 generates MRR data, the server 2000 may insert additional information into the MRR data and may store the additional information in the MRR data.

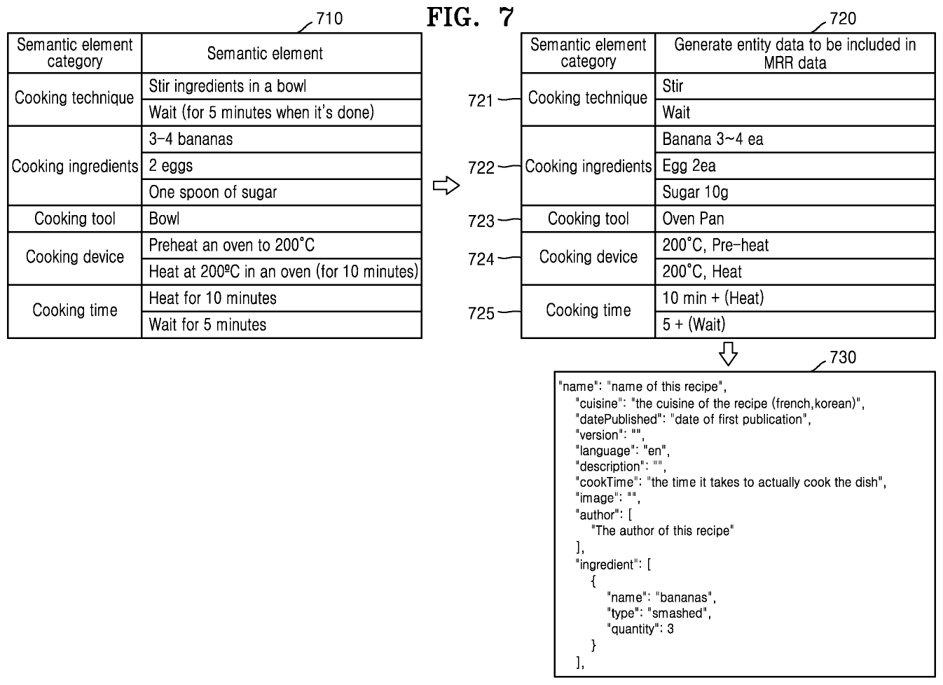

FIG. 7 is a diagram for describing a method performed by a server for generating first MRR data by using semantic elements identified from a plurality of NLU models, according to an embodiment of the disclosure.

Referring to FIG. 7, the server 2000 may identify a plurality of semantic elements 710 from text indicating a recipe, by using a plurality of NLU models. A method performed by the server 2000 for identifying the plurality of semantic elements 710 has been described with reference to FIG. 5, and thus a description thereof will be omitted for simplicity of description.

In an embodiment of the disclosure, first MRR data 730 may be data generated based on the identified semantic elements and may be data structured to be readable by a cooking device.

The server 2000 according to an embodiment of the disclosure may generate cooking device control parameters 720 corresponding to the identified semantic elements 710, by using a first MRR data generation module. In particular, the cooking device control parameters 720 may be entities included in the first MRR data and may indicate elements related to cooking in the recipe.

In an embodiment of the disclosure, a semantic element may be identified as a sentence The server 2000 may extract text that is an important keyword from the semantic element by using the first MRR data generation module, and may generate entity data to be included in the first MRR data 730. For example, the server 2000 may extract ‘stir’ as a keyword from ‘stir ingredients in a bowl’ of a cooking technique semantic element, and may generate the extracted ‘stir’ as a cooking device control parameter corresponding to a cooking technique category 721. Also, the server 2000 may extract ‘wait’ as a keyword from ‘wait for 5 minutes when it's done’ of a cooking technique semantic element, and may generate the extracted ‘wait’ as a cooking device control parameter corresponding to the cooking technique category 721.

In an embodiment of the disclosure, a semantic elements may be identified as a word. The server 2000 may extract, as a keyword, a semantic element identified as a word, by using the first MRR data generation module, and may generate a cooking device control parameter to be included in the first MRR data. For example, the server 2000 may extract ‘banana 3˜4 ea’ as a keyword from ‘3˜4 bananas’ of a cooking ingredient semantic element, and may generate the extracted ‘banana 3˜4 ea’ as a cooking device control parameter corresponding to a cooking ingredient category 722. Also, the server 2000 may extract ‘egg 2ea’ as a keyword from ‘2 eggs’ of a cooking ingredient semantic element, and may generate the extracted ‘egg 2ea’ as a cooking device control parameter corresponding to the cooking ingredient category 722.

In an embodiment of the disclosure, an identified semantic element may be identified as a general pronoun (e.g., ‘bowl’) due to the nature of a text recipe. The server 2000 may generate a cooking device control parameter to be included in the first MRR data by changing a corresponding semantic element into a suitable keyword, by using the first MRR data generation module. For example, the server 2000 may generate ‘oven pan’ that is a bowl suitable for an oven and is changed from ‘bowl’ that is the identified semantic element of a cooking tool category 723, as a cooking device control parameter corresponding to the cooking tool category 723, with reference to ‘heat at 200° C. for 10 minutes in an oven’, by using the first MRR data generation module.

In an embodiment of the disclosure, when an extracted semantic element includes a plurality of keywords required for cooking, the server 2000 may generate a cooking device control parameter as a combination of the plurality of keywords.

For example, the server 2000 may extract ‘200° C. and oven preheat’ that are two keywords from ‘preheat the oven to 200° C.’ that is a semantic element of a cooking device category 724, and may generate a cooking device control parameter to be included in the first MRR data 730. In another embodiment of the disclosure, the server 2000 may extract ‘200° C. and heat’ that are two keywords from ‘heat at 200° C. for 10 minutes in an oven’ that is a semantic element of the cooking device category 724, and may generate a cooking device control parameter to be included in the first MRR data 730.

Also, for a semantic element of a cooking time category 725, the server 2000 may generate a cooking device control parameter by also extracting a keyword indicating which cooking operation is included. For example, the server 2000 may extract ‘10 min and heat’ that are two keywords from ‘heat for 10 minutes’ that is a semantic element of the cooking time category 725, and may generate a cooking device control parameter. In another embodiment of the disclosure, the server 2000 may extract ‘5 min and wait’ that are two keywords from ‘wait for 5 minutes’ that is a semantic element of the cooking time category 725, and may generate a cooking device control parameter to be included in the first MRR data 730.

In an embodiment of the disclosure, from among cooking device control parameters included in the first MRR data 730, cooking device control parameters of the cooking device category 724 and the cooking time category 725 may be related to a control operation of the cooking device.

The server 2000 may generate the cooking device control parameters 720 to be included in the first MRR data 730 from the identified semantic elements 710, and may generate the first MRR data 730 by inserting the generated cooking device control parameters 720 into a format of the structured first MRR data, by using the first MRR data generation module. Although the first MRR data written in a JSON format is illustrated in FIG. 7 for convenience of explanation, the disclosure is not limited thereto. The first MRR data 730 may be implemented and structured in any of various programming languages.

The first MRR data 730 according to an embodiment of the disclosure may include name, cuisine, dataPublished, version, language, cookTime, image, author, ingredient, etc. which are basic recipe information for managing recipe information (e.g., storing and searching for each category). The basic recipe information may be extracted from the text indicating the recipe obtained by the server 2000, and when there is no corresponding information, the basic recipe information may be left blank, and may be updated through information received from the user or information input from an external device.

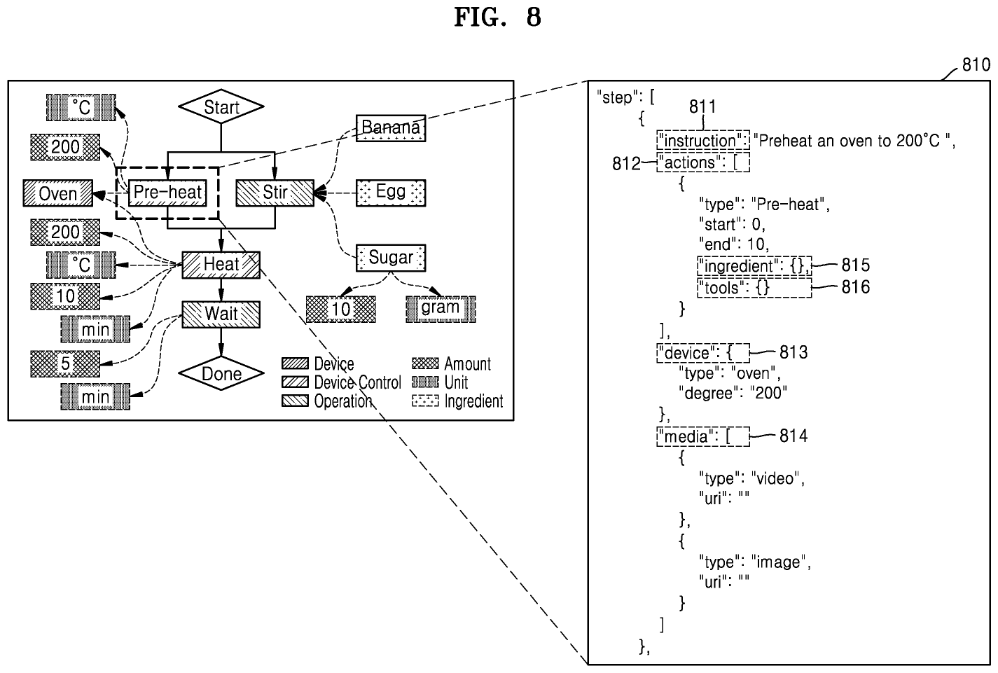

FIG. 8 is a diagram for describing a method, performed by a server, of identifying semantic elements from text indicating a recipe by using a first MRR data generation module, generating cooking device control parameters, and thus generating first MRR data so that the recipe is readable by a cooking device, according to an embodiment of the disclosure.

The server 2000 may put cooking device control parameters generated from semantic elements into a structured area and may store the cooking device control parameters, by using a first MRR generation module. FIG. 8 illustrates first MRR data 810 corresponding to a preheating step from among a plurality of cooking steps included in a recipe for convenience of explanation.

Referring to FIG. 8, first MRR data may include cooking step information in each cooking step. For example, in the first MRR data 810 corresponding to the oven preheating step, cooking device control parameters generated from semantic elements may be structured to include a plurality of data areas.

For example, the plurality of data areas may include an instruction area 811 indicating an original sentence of the recipe, an action area 812 indicating data determined as a cooking operation, a device area 813 indicating data determined as a cooking device-related expression, and a media area 814 indicating content (e.g., a video or an image) that is additional information matchable to a cooking step.

In this case, although the action area 812 from among the data areas included in the first MRR data may include an ingredient area 815 related to cooking ingredients and a tool area 816 related to a cooking tool, the disclosure is not limited thereto.

In an embodiment of the disclosure, the action area 812 from among the data areas included in the first MRR data 810 corresponding to the oven preheating step may include cooking device control parameters indicating ‘cooking operation, start, end, ingredients, and tool’ as a sub-structure. Also, the device area 813 may include cooking device control parameters indicating ‘cooking device type and cooking temperature’ as a sub-structure. Also, the media area 814 may include additional information data such as ‘content type and url of content’ as a sub-structure. The additional information data may be generated by an additional information generation module.

The server 2000 according to an embodiment of the disclosure may generate first MRR data by inserting cooking device control parameters into each data area, by using the first MRR data generation module.

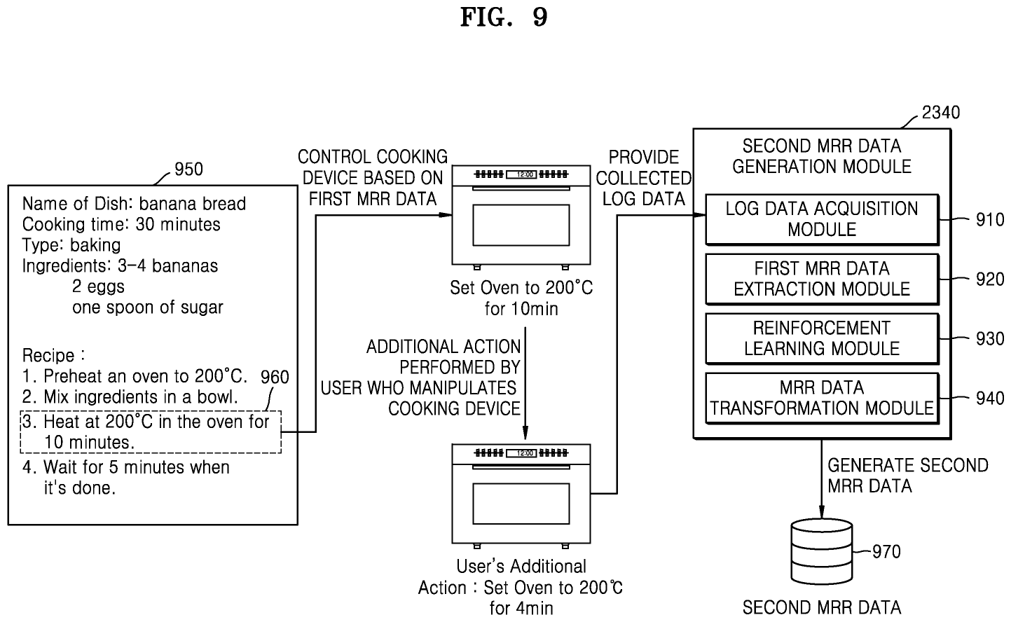

FIG. 9 is a diagram for describing a method performed by a server for obtaining log data of a user and generating second MRR data based on the obtained log data, according to an embodiment of the disclosure.

Referring to FIG. 9, the second MRR data generation module 2340 according to an embodiment of the disclosure may include at least a log data acquisition module 910, a first MRR data extraction module 920, a reinforcement learning module 930, and an MRR data transformation module 940.

The server 2000 according to an embodiment of the disclosure may obtain log data of a user by using the log data acquisition module 910. The log data of the user may include parameters related to a control operation of a cooking device such as an operation temperature, an operation time, and the number of operations of the cooking device, and may include evaluation of the user for a completed dish.

In an embodiment of the disclosure, the log data of the user may be generated from the cooking device and may be provided to the server 2000. For example, the log data of the user may be generated for all device control actions performed by the user to operate the cooking device, may be provided to the server 2000, and may be stored in a database of the server 2000. In another embodiment of the disclosure, the log data of the user may be generated for device control actions performed by the user to operate the cooking device, different from cooking device control parameters included in first MRR data, and then may be stored in the database of the server 2000.

In the above embodiments of the disclosure, the server 2000 may identify semantic elements in text 950 indicating a recipe, and may generate first MRR data.

Also, the server 2000 may control the cooking device based on the first MRR data. The cooking device may perform a control operation based on cooking device control parameters included in the first MRR data.

For example, the server 2000 may provide control information to the cooking device, based on a cooking device control parameter generated from a cooking step 960 for ‘heat at 200° C. for 10 minutes in an oven’. The cooking device may perform a control operation for ‘heat at 200° C. and 10 minutes’ based on the received control information. In this case, the user may input an operation of additionally controlling the cooking device. In detail, when the first MRR data may be generated based on a microwave oven having an output of 1000 watts (W) and a microwave oven of the user has an output of 700 W, the user may additionally input an operation of heating the 700 W microwave oven for additional cooking. Also, when the user prefers more heated and crispy food according to the user's preference, the user may additionally input an operation of additionally heating at 200° C. for 4 minutes after an operation of heating at 200° C. for 10 minutes in an oven.

The server 2000 according to an embodiment of the disclosure may collect log data of the user related to an operation of controlling the cooking device of the user, and may store the log data in the database of the server. Also, the server 2000 may obtain stored log data of the user by using the log data acquisition module 910, and may generate second MRR data 970 based on the obtained log data.

In an embodiment of the disclosure, the server 2000 may extract cooking device control parameters related to the control operation of the cooking device in the first MRR data, by using the first MRR data extraction module 920. In this case, the server 2000 may generate the second MRR data 970 by updating the cooking device control parameters in the first MRR data, by using the MRR data transformation module 940.

In detail, the server 2000 may extract cooking device control parameters generated from the cooking step for ‘heat at 200° C. for 10 minutes in an oven’ in the first MRR data, by using the first MRR data extraction module 920. In this case, the extracted cooking device control parameters may indicate ‘heat at 200° C. and 10 minutes’. Also, the log data of the user may be ‘additionally heat at 200° C. and 4 minutes’. The server 2000 may generate the second MRR data 970 that is MRR data personalized to the user, by updating ‘heat at 200° C. and 10 minutes’ that are the cooking device control parameters in the first MRR data to ‘heat at 200° C. and 14 minutes,’ by using the MRR data transformation module 940.

In generating the second MRR data 970, the server 2000 may determine whether the additional action is taken as part of the same cooking process that is started using the first MRR data. For example, the server 2000 may determine whether the oven door is opened and the weight of the oven rack has changed, by using one or more sensors mounted in the oven (e.g., a door sensor such as a reed switch, a weight scale for sensing the weight of the oven rack, etc.) to determine the additional action is taken as part of the same cooking process. The server 2000 may also identify the time at which the additional action is taken, and may determine the additional action is taken as part of the same cooking process if the additional action occurs before the end of the originally set cooking time (e.g., 10 minutes) or within a predetermined time period (e.g., 5 minutes) from the end of the originally set cooking time.

Various methods may be used as a method, performed by the server 2000 according to an embodiment of the disclosure, of generating the second MRR data 970 by updating the first MRR data.

For example, when the number of times the user operates the cooking device in a specific mode is equal to or greater than a certain number of times based on the log data of the user, the server 2000 may update the plurality of cooking device control parameters included in the first MRR data to values corresponding to the log data of the user.

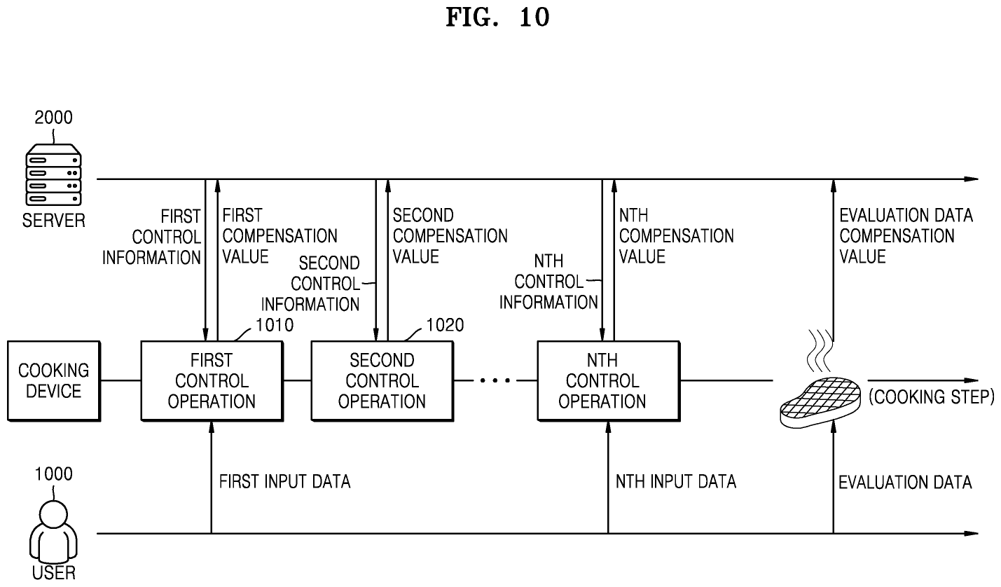

In another embodiment of the disclosure, the server 2000 may generate the second MRR data 970 by performing reinforcement learning using the log data of the user, by using the reinforcement learning module, which will be described in detail with reference to FIG. 10.

FIG. 10 is a diagram for describing an embodiment of the disclosure where the server 2000 performs reinforcement learning based on log data of a user when second MRR data is generated, according to an embodiment of the disclosure.

Referring to FIG. 10, the server 2000 according to an embodiment of the disclosure may provide control information for controlling a cooking device to the cooking device, based on first MRR data. As the server 2000 provides the control information to the cooking device, the cooking device may perform control operations.

In an embodiment of the disclosure, the server 2000 may obtain compensation values for the control operations of the cooking device corresponding to the control information. In this case, the compensation values may be determined based on log data of a user. For example, the compensation values may be determined based on cooking device control parameters related to the control operations of the cooking device manipulated by the user, and in detail, the compensation values may be determined based on an operation mode, an operation temperature, an operation time, and the number of operations of the cooking device manipulated by the user. In this case, each of the compensation values may have a positive value or a negative value.

In detail, in an embodiment of the disclosure, the log data of the user may include a cooking device operation history corresponding to ‘additionally heat at 200° C. and 4 minutes’. In this case, in order to perform reinforcement learning so that the cooking device performs a control operation for ‘additionally heat at 200° C. and 4 minutes,’ a compensation value may be determined to be a positive value. In another embodiment of the disclosure, the log data of the user includes a cooking device operation history corresponding to ‘additionally heat at 200° C. and 4 minutes,’ but may further include negative evaluation of the user on a corresponding control operation or a completed dish. In this case, in order to perform reinforcement learning so that the cooking device does not perform a control operation for ‘additionally heat at 200° C. and 4 minutes,’ a compensation value may be determined to be a negative value.

The server 2000 according to an embodiment of the disclosure may obtain the compensation values for the control operations of the cooking device corresponding to the control information.

For example, as the server 2000 provides first control information to the cooking device and the cooking device performs a first control operation 1010, the server 2000 may obtain a first compensation value corresponding to the first control operation 1010. In detail, when the first control operation 1010 is performed to match the log data of the user within a certain error range, the server 2000 may obtain the first compensation value.

In this case, the first control operation 1010 may include not only a control operation performed by the cooking device by receiving the first control information from the server but also an additional device control action performed by a user 1000 by receiving first input data of the user who manipulates the cooking device while the cooking device operates. Also, the first input data received from the user 1000 while the cooking device operates may be collected as the log data of the user and may be stored in a database in the server 2000. The server 2000 may allocate the first input data that is the stored log data to a compensation value.

Also, as the server 2000 provides second control information to the cooking device and the cooking device performs a second control operation 1020, the server 2000 may obtain a second compensation value corresponding to the second control operation 1020. In detail, when the second control operation 1020 is performed by the cooking device to match the log data of the user within a certain error range, the server 2000 may obtain the second compensation value.

In this case, the second control operation 1020 may include not only a control operation performed by the cooking device by receiving the second control information from the server but also an additional device control action performed by the user 1000 by receiving input data of the user who manipulates the cooking device while the cooking device operates. Also, referring to FIG. 10, as the second control operation 1020 is performed by the cooking device without receiving input data of the user, the second compensation value may be obtained.

In the same manner, as the server 2000 provides Nth control information to the cooking device and the cooking device performs an Nth control operation, the server 2000 may obtain an Nth compensation value for the Nth control operation.

The server 2000 according to an embodiment of the disclosure may receive evaluation data of the user on food cooked by an operation of the cooking device. In this case, the server 2000 may receive the evaluation data of the user from the client device 3000 of the user, or the user 1000 may input the evaluation data to the cooking device and the server 2000 may receive the evaluation data of the user from the cooking device.

Also, the evaluation data on the cooked food received from the user 1000 may be collected as log data of the user and may be stored in the database in the server 2000. The server 2000 may allocate the evaluation data of the user that is the stored log data may be allocated to a compensation value.

The server 2000 according to an embodiment of the disclosure may generate second MRR data by updating cooking device control parameters included in first MRR data, based on an accumulated sum of compensation values obtained from control operations corresponding to cooking steps of food. For example, the server 2000 may update the cooking device control parameters included in the first MRR data so that the obtained accumulated sum of the compensation values is maximized, but the disclosure is not limited thereto.

A method, performed by the server 2000 according to an embodiment of the disclosure, of generating the second MRR data by updating the cooking device control parameters included in the first MRR has been described with reference to FIG. 9, and thus a description thereof will be omitted.

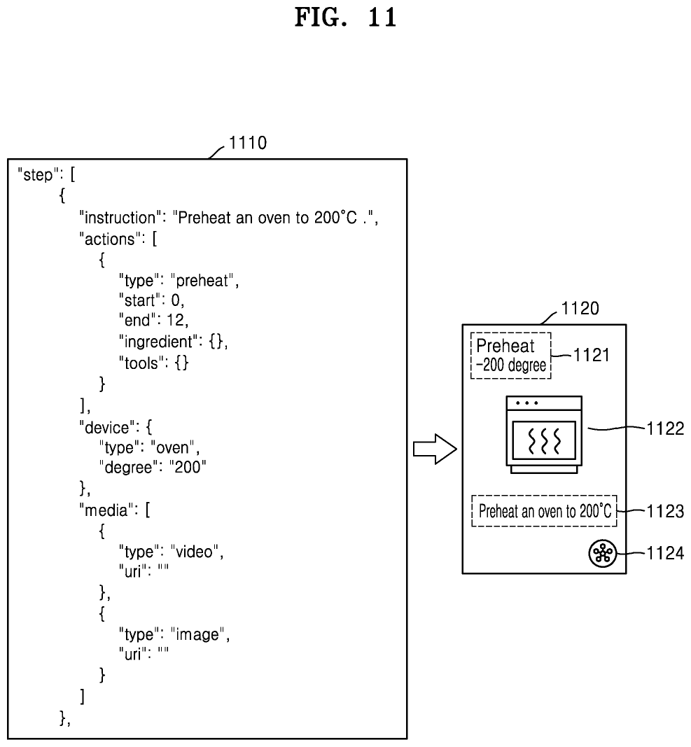

FIG. 11 is a diagram for describing a method, performed by a server, of generating a recipe card, according to an embodiment of the disclosure.

The server 2000 according to an embodiment of the disclosure may generate a plurality of first recipe cards, by using generated first MRR data and generated additional information. The generated first recipe cards may be provided to the client device 3000.

In FIG. 11, first MRR data 1110 corresponding to a preheating step from among a plurality of cooking steps included in a recipe described with reference to FIG. 8 will be described as an example.

Referring to FIG. 11, the first MRR data 1110 corresponding to the preheating step may include ‘preheat’ that is information on a cooking operation, ‘oven’ that is information on a cooking device, and ‘200° C.’. Also, the first MRR data 1110 may further include additional information related to a cooking step (e.g., a cooking video received in the preheating step).

The server 2000 according to an embodiment of the disclosure may generate a first recipe card 1120 corresponding to a preheating cooking step by using the first MRR data and the additional information.

The first recipe card 1120 generated by using the first MRR data 1110 may include summary information 1121 representatively summarizing a current cooking step, content information 1122 indicating content related to additional information (e.g., an image or a video) corresponding to the current cooking step, text sentence information 1123 indicating an original recipe indicating the current cooking step, and information 1124 indicating an interoperable function in the current cooking step.

The summary information 1121 of the first recipe card 1120 according to an embodiment of the disclosure may be generated when the server 2000 interprets text by using an NLU model and obtains intent information determined to indicate the intent of the text. For example, when text for a cooking step is ‘preheat the oven to 200° C.,’ intent information determined to be the intent of the text may be ‘preheat’.

Although not shown in FIG. 11, in another example, the intent information determined to be the intent of the text may be ‘cooking preparation step’. When the server 2000 generates the first recipe card 1120, the server 2000 may determine the summary information 1121 to be included in the first recipe card 1120 by using the intent information.

The content information 1122 of the first recipe card 1120 according to an embodiment of the disclosure may be obtained by searching for an image or a video related to a current cooking step, or may be obtained together when the text indicating the recipe is obtained. For example, when the text for the cooking step is ‘preheat the oven to 200° C.,’ the server 2000 may obtain an image of guiding an oven preheating operation based on semantic elements identified from the text. In another example, the server 2000 may obtain an image or a video of guiding matters required for cooking preparation, based on the ‘cooking preparation step’ that is the intent information determined to be the intent of the text. When the server 2000 generates the first recipe card, the server 2000 may determine the content information 1122 to be included in the first recipe card 1120.

The recipe sentence information 1123 of the first recipe card 1120 according to an embodiment of the disclosure may be an original sentence of the recipe based on which the first recipe card is generated.

In an embodiment of the disclosure, as a result obtained when the server 2000 recognizes the text by using the NLU model, when a recipe sentence for a corresponding cooking step is too long to be displayed on the first recipe card 1120, the server 2000 may divide and display the sentence based on the semantic elements identified in the text.

In another embodiment of the disclosure, when recipe sentences are too short to convey meaning indicating a recipe step in units of sentences, the server 2000 may generate a recipe sentence and may determine the recipe sentence information 1123 to be included in the first recipe card 1120, based on the semantic elements identified in the text.

The information 1124 indicating an interoperable function of the first recipe card 1120 according to an embodiment of the disclosure may be generated by the server by using additional information generated based on the semantic elements identified in the text.

In one embodiment of the disclosure, the information 1124 indicating the interoperable function may include a control linking function for controlling a cooking device that operates in a current cooking step, an advertisement/purchase linking function for providing advertisement and purchase related to a cooking tool and cooking ingredients required in a cooking step, an alternative cooking method content provision linking function for replacing a cooking method of a corresponding step, and a guide information provision linking function for guiding a result of a change in taste information, cooking ingredients, and a cooking amount as a cooking time applied for each cooking step increases or decreases.

Also, the server 2000 according to an embodiment of the disclosure may generate a second recipe card including cooking information personalized to the user by using second MRR data and additional information. This is the same as a method of generating the first recipe card 1120, and thus a description thereof will be omitted.

The user of the client device may receive the first recipe card 1120 or the second recipe card according to an embodiment of the disclosure, and may receive an interaction with the server and the cooking device through the first recipe card 1120 or the second recipe card.

For example, the user of the client device may control the cooking device, may purchase a cooking tool required for a cooking step, may receive content related to cooking, or may receive information for guiding a cooking method, by clicking an icon indicating the information 1124 indicating the inoperable function of the first recipe card 1120 according to an embodiment of the disclosure.

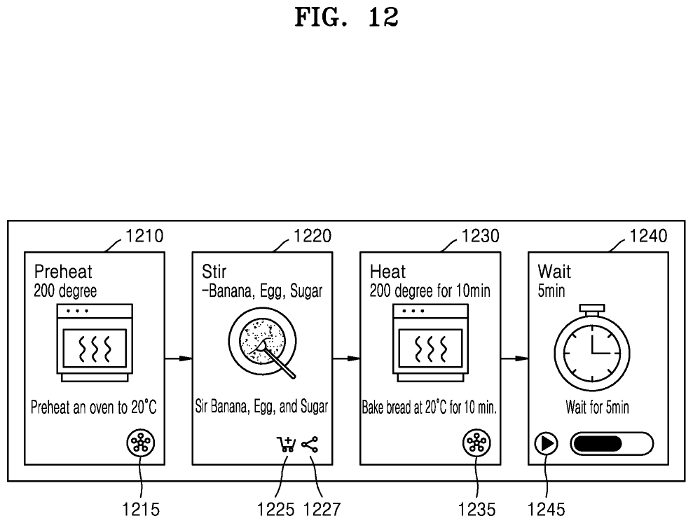

FIG. 12 is a diagram for describing a method, performed by a server, of generating a recipe card for each cooking step, according to an embodiment of the disclosure.

In FIG. 12, a recipe card may be a first recipe card generated from first MRR data, and may be a second recipe card including cooking information personalized to a user generated from second MRR data. For convenience of explanation, both a first recipe card and a second recipe card are referred to as ‘recipe cards’.

Referring to FIG. 12, the server 2000 may generate a recipe card in each cooking step for a ‘banana bread recipe,’ by using generated MRR data and generated additional information. In this case, a cooking step of the ‘banana bread recipe’ may include first through fourth steps.

The server 2000 may determine a type of a cooking step in the recipe by using identified semantic elements. The server 2000 may determine a type of a recipe card corresponding to each cooking step based on the determined type of the cooking step, MRR data, and additional information. Also, one recipe card is not limited to only one type, and one recipe card may include a plurality of types.

For example, the determined type of the recipe card may be a cooking device control type. In an embodiment of the disclosure, because a first cooking step corresponding to a recipe card 1210 indicating a first cooking step is ‘preheat’ and a third cooking step corresponding to a recipe card 1230 indicating a third cooking step is ‘heat,’ the first cooking step and the third cooking step may require control of an oven that is a cooking device. In this case, recipe cards respectively corresponding to the first cooking step and the third cooking step may include cooking device control buttons 1215 and 1235. The server 2000 may receive a cooking device control request according to an input of a user who selects the cooking device control buttons 1215 and 1235 from the client device 3000. When the server 2000 according to an embodiment of the disclosure receives the cooking device control request, the server 2000 may provide cooking device control information included in the MRR data to the cooking device to control the cooking device.

In another embodiment of the disclosure, the determined type of the recipe card may be a cooking item purchase type. In an embodiment of the disclosure, a recipe card 1220 indicating a second cooking step may include a cooking item purchase button 1225. In this case, the server 2000 may receive a purchase information provision request according to an input of the user who selects the cooking item purchase button 1225 from the client device 3000. Cooking items that are purchasable from the cooking item purchase button 1225 may include various items related to cooking of a corresponding recipe such as cooking ingredients and a cooking tool. When a recipe card is generated, the server 2000 may add additional information such as advertisement information or purchase information, in relation to a cooking item included in a cooking step, to the recipe card. When the server 2000 receives a cooking item purchase information provision request, the server 2000 may provide cooking item purchase information to the client device 3000.

In another embodiment of the disclosure, the determined type of the recipe card may be a cooking information provision type. In an embodiment of the disclosure, the recipe card 1220 indicating the second cooking step and a recipe card 1240 indicating a fourth cooking step may respectively include cooking information provision buttons 1227 and 1245. In this case, the server 2000 may receive a cooking information provision request according to an input of the user who selects the cooking information provision button 1227 from the client device 3000.

Additional information related to cooking information provision may include image or photograph information on a cooking technique, sub-recipe information derived from a corresponding recipe, information on a cooking time, and plating information of a completed dish. The server 2000 may provide cooking information on a cooking step corresponding to a recipe card to the client device 3000, according to an input of the user who selects the cooking information provision button 1245 from the client device 3000.

Although a cooking device control type, a cooking item purchase type, and a cooking information provision type have been described as types of recipe cards in the above embodiments of the disclosure, these are merely examples. Types of recipe cards may be determined to provide various functions related to cooking and information related to cooking by using MRR data and additional information.

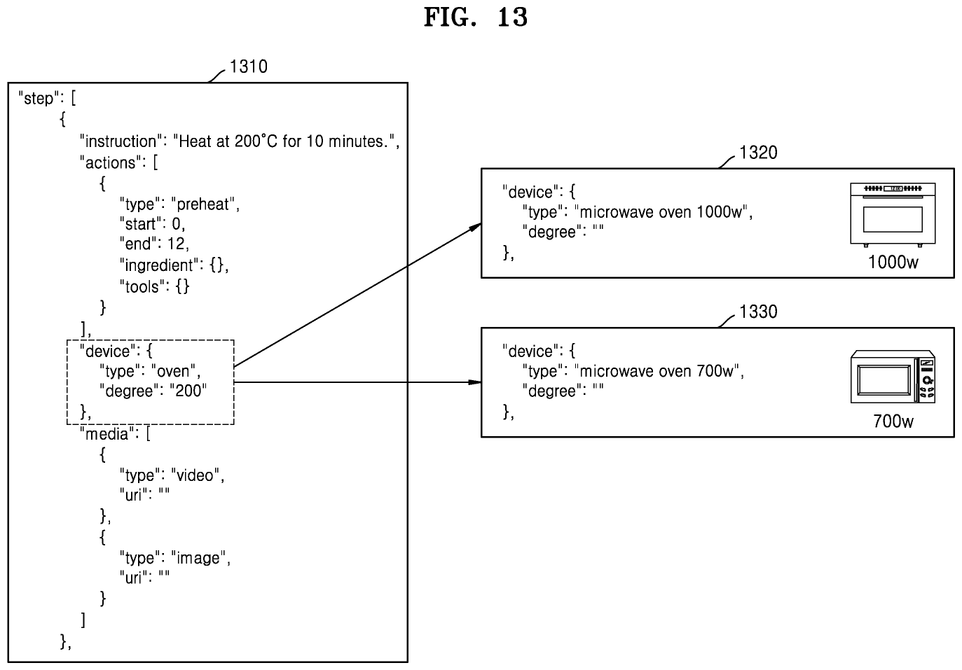

FIG. 13 is a diagram for describing a method, performed by a server, of changing and optimizing generated MRR data according to a cooking device of a user, according to an embodiment of the disclosure.

In FIG. 13, MRR data may be first MRR data or second MRR data personalized to a user according to the above embodiments of the disclosure. Hereinafter, for convenience of explanation, both first MRR data and second MRR data are referred to as ‘MRR data’.

When generated MRR data is not suitable for a cooking device owned by a user, the server 2000 may change the MRR data so that food is cooked by another cooking device owned by the user.

For example, in a cooking step, MRR data 1310 generated for ‘heat at 200° C. for 10 minutes in an oven’ may be generated based on an oven. In this case, the server 2000 may receive cooking device identification information of the user from the client device 3000.

When the received cooking device identification information of the user is a 2000 W microwave oven, the server 2000 may change ‘cook at 200° C. for 10 minutes in an oven’ that is data indicating a cooking operation in the MRR data into ‘cook for 10 minutes in a 2000 W microwave oven,’ and may generate MRR data 1320 for a 2000 W microwave oven.

Also, when the received cooking device identification information of the user is 700 W microwave oven, the server 2000 may change ‘cook at 200° C. for 10 minutes in an oven’ that is data indicating a corresponding operation in the MRR data into ‘cook for 15 minutes in a 700 W microwave oven,’ and may generate MRR data 1330 for a 700 W microwave oven.

In another example (not shown), in MRR data generated for ‘heat in warm water for 2 days (sous-vide)’ in a cooking step, a sous-vide cooking method may be a function that may be used only in a specific cooking device and is not supported by a cooking device owned by the user. In this case, the server 2000 may receive cooking device identification information of the user from the client device 3000.

Based on the received cooking device identification information of the user, the server 2000 may change the MRR data into a function related to a cooking device of the user that may replace the sous-vide cooking method.

In another example (not shown), MRR data generated for ‘stir ingredients in a bowl’ in a cooking step may be a function that is provided in a specific cooking device but is not provided in another cooking device. In this case, the server 2000 may receive cooking device identification information of the user from the client device 3000.

Based on the received cooking device identification information of the user, when a function of a cooking device indicated the MRR data is a function that may not be performed in a cooking device of the user, the server 2000 may change and provide a recipe card corresponding to the MRR data into content for guiding the user to directly stir cooking ingredients.

The server 2000 may obtain identification information of another cooking device, and may change at least part of the MRR data so that food is cooked by the other cooking device, based on the identification information of the other cooking device.

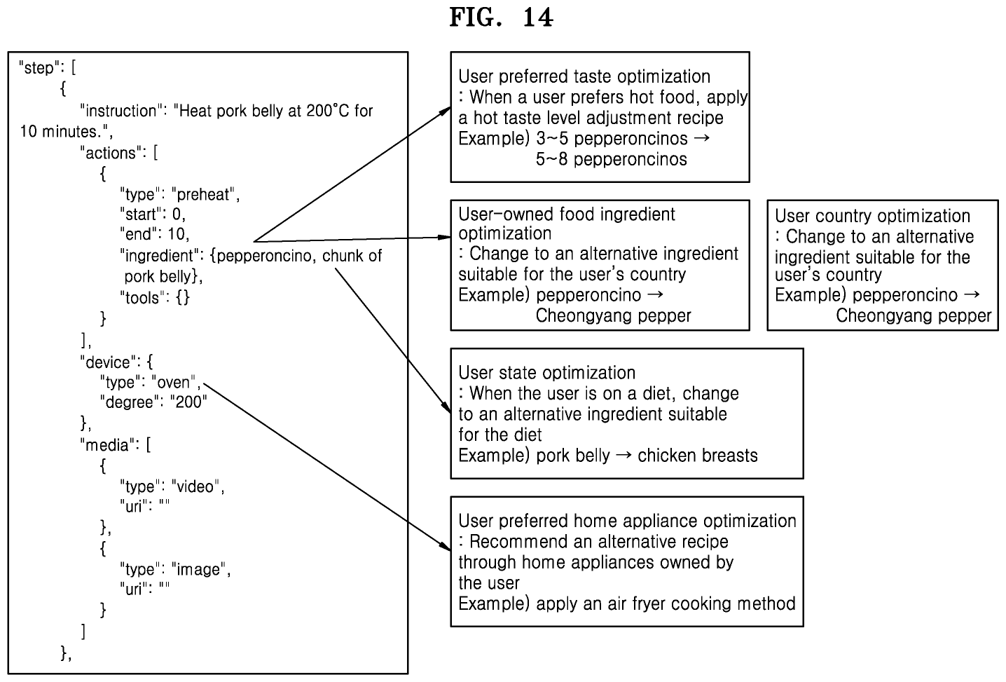

FIG. 14 is a diagram for describing a method, performed by a server, of changing and optimizing generated MRR data based on various user information, according to an embodiment of the disclosure.

In FIG. 14, MRR data may be first MRR data or second MRR data personalized to a user according to the above embodiments of the disclosure. Hereinafter, for convenience of explanation, both first MRR data and second MRR data are referred to as ‘MRR data’.

Referring to FIG. 14, the server 2000 may obtain text indicating a recipe of ‘pork belly pasta,’ and may generate MRR data according to the above embodiments of the disclosure.

In an embodiment of the disclosure, the server 2000 may receive characteristic information about characteristics of food input by a user from the client device 3000. The characteristic information of food input by the user may include taste characteristics of food (e.g., degree of hotness, sweetness, or saltiness), and heating characteristics of food (e.g., rare or medium rare), but the disclosure is not limited thereto. The characteristic information of food may include various information that is related to food cooing and may be changed by the user.

The server 2000 may change at least part of the MRR data generated from the text indicating the recipe of ‘pork belly pasta,’ based on the received characteristic information.

For example, the server 2000 may change the MRR data based on taste preference of the user included in the characteristic information received from the user. When the user prefers hot food, the server 2000 may change MRR data indicating ‘3-5 pepperoncinos and 1 teaspoon of red pepper powder’ related to hot taste in the MRR data into data of ‘5-8 pepperoncinos and 2 teaspoons of red pepper powder’.

In another embodiment of the disclosure, the server 2000 may obtain food ingredient information of the user. The food ingredient information of the user that is input by the user may be received by the server 2000 from the client 3000, may be received by the server 2000 from a smart home appliance (e.g., a refrigerator) capable of performing data communication with the server 2000, or may be received by the server 2000 from another server (e.g., a cloud server).

The server 2000 may change at least part of first MRR data generated from the text indicating the recipe of ‘pork belly pasta,’ based on the food ingredient information of the user.

For example, when alternative cooking is possible by using food ingredients owned by the user without needing to purchase new food ingredients, the server 2000 may change MRR data indicating ‘pepperoncino’ in the MRR data into data of ‘Cheongyang pepper’ that may replace pepperoncino.

However, embodiments where the server 2000 changes MRR data are not limited thereto, and the server 2000 may optimize MRR data according to user tendency/state/situation, by changing the MRR data by using various information of the user which may be applied to recipes.

For example, the server 2000 may change MRR data based on country/region information of the user. When it is difficult to purchase ‘pepperoncino’ that is an ingredient required in a recipe in a country/region where the user is located, the server 2000 providing cooking information may change data related to ‘pepperoncino’ in the MRR data into data related to ‘Cheongyang pepper’ that may replace pepperoncino.

In another example, the server 2000 may change the MRR data based on health information of the user. When the user is on a diet, the server 2000 may change data related to ‘pork belly’ in the MRR data to data related to ‘chicken breasts’.

In another example, the server 2000 may change the generated MRR data by using cooking device information preferred by the user. When a cooking device preferred by the user is an ‘air fryer,’ the server 2000 may change data related to an operation of an ‘oven’ in the MRR data into data related to an operation of an ‘air fryer’.

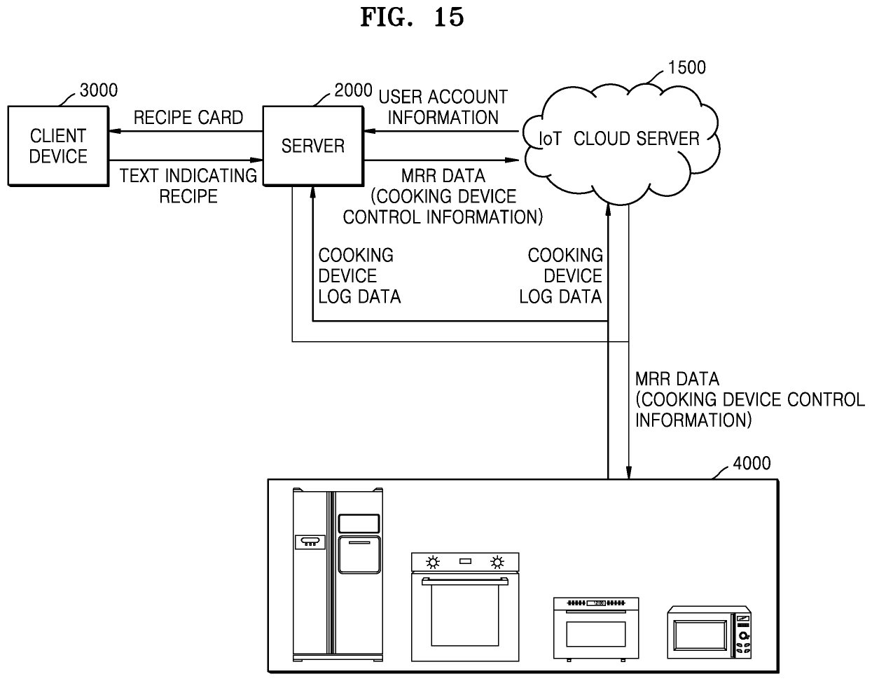

FIG. 15 is a diagram for describing elements of a cooking information providing system, according to an embodiment of the disclosure.

Referring to FIG. 15, a cooking device system according to an embodiment of the disclosure may include the server 2000, an IOT cloud server 1500, the client device 3000, and cooking-related devices 4000 of a user.

The server 2000 according to an embodiment of the disclosure may obtain text indicating a recipe from the client device 3000 or an external source, and may generate first MRR data and a first recipe card by analyzing the text.

The server 2000 may provide cooking information to the user, by transmitting the first recipe card to the client device 3000. Also, the server 2000 may control the cooking-related devices 4000 of the user by using the generated first MRR data.

Also, the server 2000 may obtain log data of the user related to device control actions performed by the user to operate the cooking-related devices 4000 from the cooking-related devices 4000 of the user. The server 2000 may generate second MRR data personalized to the user by changing at least part of the first MRR data, based on the log data of the user. Also, the server 2000 may generate a second recipe card for providing cooking information personalized to the user based on the second MRR data.

The server 2000 may provide cooking information to the user by transmitting the second recipe card to the client device 3000, and may control the cooking-related devices of the user by using the second MRR data.

Operations of the server 2000 according to an embodiment of the disclosure may be performed by using the IOT cloud server 1500. For example, the IOT cloud server 1500 may register the cooking-related devices 4000 of the user in the user's account, and may manage the cooking-related devices 4000 of the user. The IOT cloud server 1500 may collect log data from the cooking-related devices 4000 of the user, and may transmit account information of the user including the collected log data to the server 2000.

Also, the IOT cloud server 1500 may receive MRR data (e.g., first MRR data or second MRR data) from the server 2000, and may control cooking devices registered in the user's account based on the received MRR data.

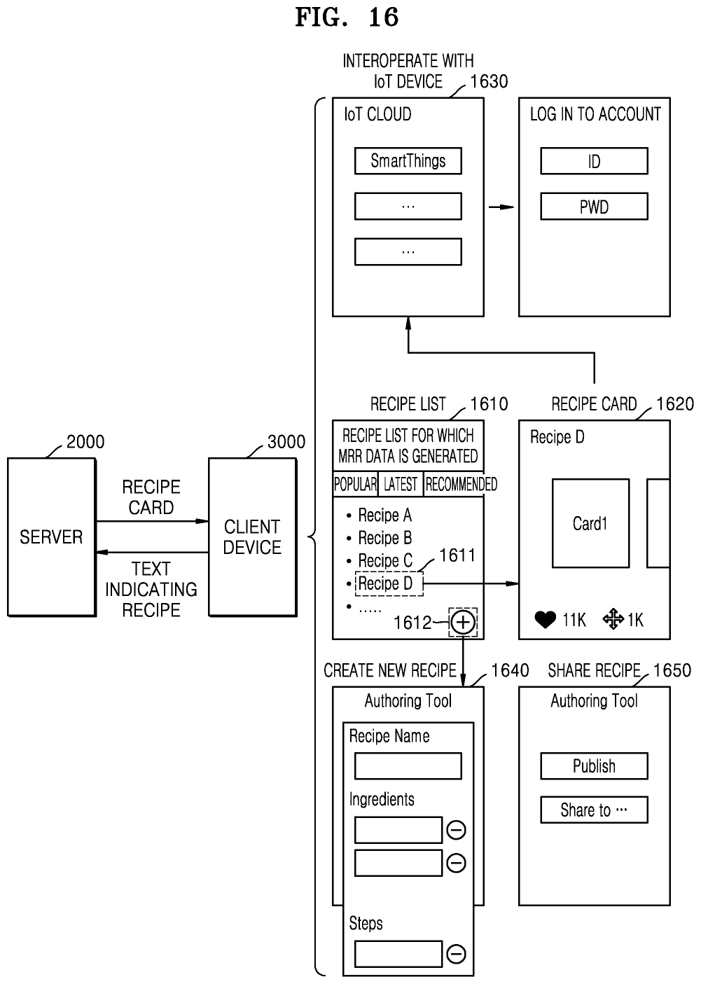

FIG. 16 is a diagram for describing an example where a server generates MRR data and recipe cards and then information for food cooking is provided to a user through a client device, according to an embodiment of the disclosure.

In FIG. 16, MRR data may be first MRR data or second MRR data personalized to a user according to the above embodiment of the disclosures. Also, a recipe card may be a first recipe card or a second recipe card according to the above embodiments of the disclosure. Hereinafter, for convenience of explanation, both first MRR data and second MRR data are referred to as ‘MRR data,’ and both a first recipe card and a second recipe card are referred to as ‘recipe cards’.

A cooking information providing system according to an embodiment of the disclosure may include the server 2000 and the client device 3000. Also, the cooking information providing system may further include a cloud server, to provide cooking in association with a cooking device of a user.

Referring to FIG. 16, the server 2000 according to an embodiment of the disclosure may receive text indicating a recipe from the client device 3000, and may generate MRR data and a recipe card according to the above embodiments of the disclosure.

The server 2000 according to an embodiment of the disclosure may provide the generated MRR data and the generated recipe card to the client device 3000, so that the user who cooks food controls the cooking device and receives information on food cooking. In this case, the client device 3000 may be a mobile device such as a smartphone or a tablet PC that is portable by the user. Also, the client device 3000 may be a desktop PC, a laptop PC, a TV, or a refrigerator that is any of various devices capable of executing an application and a web service. Also, the client device 3000 may be a cooking device including a display and capable of receiving information on food cooking.

The server 2000 according to an embodiment of the disclosure may receive text indicating a plurality of recipes from the client device 3000, and may generate MRR data and recipe cards for each of the text indicating the plurality of recipes. The MRR data and the recipe cards generated by the server may be received by the client device 3000.

In an embodiment of the disclosure, the MRR data and the recipe cards generated by the server 2000 may be provided from the client device 3000 as applications to the user. In this case, the client device 3000 may display a list 1610 (referred to as a recipe list) of the recipes for which the MRR data are generated.

When the client device 3000 receives an input that selects one recipe in the recipe list 1610 from the user of the client device 3000, the client device 3000 may display recipe cards corresponding to the recipe selected by the user.

For example, when the user of the client device selects ‘recipe D 1611’ in the recipe list 1610, the client device 3000 may display recipe cards 1620 corresponding to the ‘recipe D’. The client device 3000 may provide various functions related to cooking (e.g., controlling a cooking device and purchasing a cooking item) and information related to cooking (e.g., an ingredient preparation video) to the user, by using the recipe cards 1620.

In an embodiment of the disclosure, when the server 2000 provides a function related to cooking to the user by using the recipe cards 1620, the server 2000 may interoperate with a cloud service (e.g., SmartThings) provided by an IOT cloud server 1630 to control cooking devices owned by the user. In this case, when the user logs in to an IOT cloud service by using the user's account, the server 2000 may receive a cooking device list of the user and identification information for identifying the cooking devices of the user from the IOT cloud server 1630. Also, the cooking device list of the user and the identification information for identifying the cooking devices of the user may be transmitted from the IOT cloud server 1630 to the client device 3000, and then may be transmitted from the client device 3000 to the server 2000.

The server 2000 may receive the cooking device list of the user, and may change at least part of the MRR data to be data suitable for the cooking devices owned by the user. These correspond to the embodiments of FIG. 13, and thus will not be described for simplicity of explanation.

Also, the server 2000 may receive a cooking device control request according to an input of the user who selects a cooking device control button in the recipe card from the client device 3000, and may transmit cooking device control information included in the MRR data to the IOT cloud server 1630 to control the cooking devices. In this case, the IOT cloud server 1630 may control the cooking devices of the user, based on the received cooking device control information. These correspond to the embodiments of FIG. 12, and thus will not be described for simplicity of explanation.

In an embodiment of the disclosure, the server 2000 may generate MRR data for a new recipe by using the pre-generated MRR data. For example, when the user of the client device selects a new recipe generation button 1612, the client device 3000 may display a user interface 1640 for creating a new recipe, may receive an input of the user who edits the recipe, and may transmit the input to the server 2000. The client device 3000 may display a user interface 1650 for sharing the generated new recipe, to share the new recipe generated by the user.

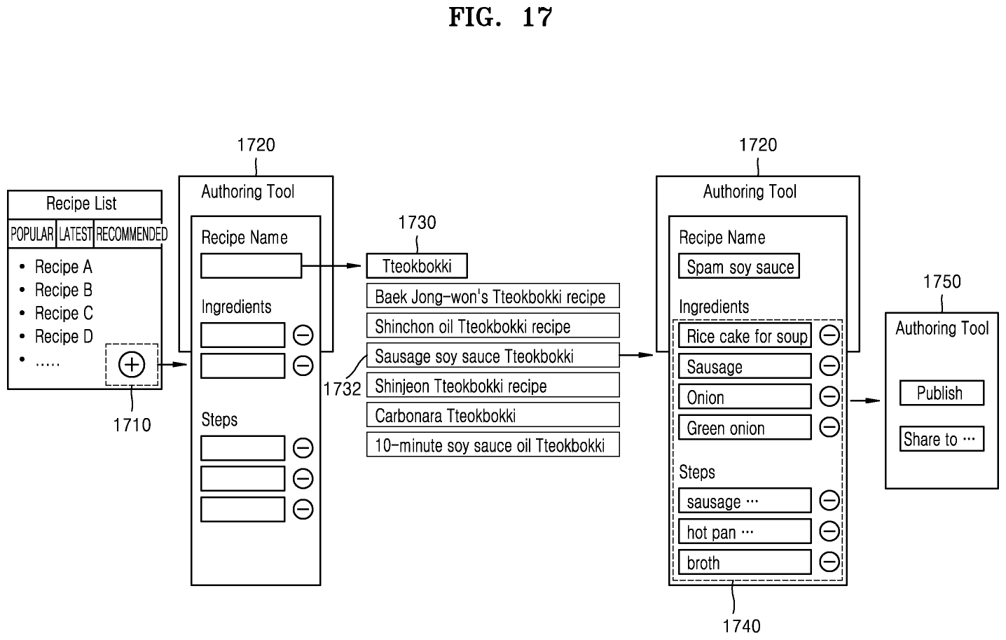

FIG. 17 is a diagram illustrating a graphical user interface (GUI) for generating MRR data for a new recipe by using previously generated multiple MRR data, in a cooking information providing system, according to an embodiment of the disclosure.

In FIG. 17, MRR data may be first MRR data or second MRR data personalized to a user according to the above embodiments of the disclosure. Hereinafter, for convenience of explanation, both first MRR data and second MRR data are referred to as ‘MRR data’.

Referring to FIG. 17, MRR data and recipe cards generated according to the above embodiments of the disclosure may be provided as applications to the user. In this case, the client device 3000 may display a list of recipes for which the MRR data are generated.

In an embodiment of the disclosure, the client device 3000 may receive an input that selects a recipe generation button 1710 from the user of the applications. The client device 3000 may display a recipe editing tool 1720, in response to a recipe generation request of the user. The user may search for MRR data for food, by inputting a name of a dish, whose recipe is to be created by the user, to the recipe editing tool. In this case, the client device 3000 may search for MRR data in a database in the server 2000 according to an embodiment of the disclosure. Also, the client device 3000 may search for MRR data stored in a memory of the client device.

In an embodiment of the disclosure, the client device 3000 may display a list 1730 of a plurality of recipes corresponding to the name of the dish input by the user. For example, when the user of the client device searches for Tteokbokki, recipes such as ‘Baek Jong-won's Tteokbokki recipe,’ Shinchon oil Tteokbokki recipe,′ and ‘sausage soy sauce Tteokbokki recipe’ may be displayed.

In an embodiment of the disclosure, based on a user input that selects one of the plurality of recipes in the searched list 1730 of the recipes, the client device 3000 may display elements included in MRR data of the selected recipe on the recipe editing tool 1720. Also, based on a user input that edits elements 1740 included in the MRR data by using the recipe editing tool 1720, the client device 3000 may generate MRR data corresponding to a new recipe.

For example, based on a user input that selects a recipe of sausage soy sauce Tteokbokki 1732 from among the plurality of recipes in the list 1730 of the recipes, the client device 3000 may obtain MRR data corresponding to the recipe of sausage soy sauce Tteokbokki 1732 from the server 2000. Alternatively, the client device 3000 may obtain MRR data corresponding to the recipe of sausage soy sauce Tteokbokki 1732′ from the memory in the client device.

The client device 3000 may display, on a screen, cooking ingredients and cooking steps that are elements included in the MRR data corresponding to the obtained recipe of sausage soy sauce Tteokbokki 1732. In this case, the ‘cooking ingredients’ may include cooking ingredients such as ‘rice cake for soup, sausage, onion, and green onion,’ and the ‘cooking steps’ may include cooking steps such as ‘sausage . . . , hot pan . . . , and broth . . . ’.

In an embodiment of the disclosure, the user of the client device may change ‘rice cake for soup’ that is a recipe element in the recipe editing tool 1720 into ‘rice cake for Tteokbokki’. When an element included in the MRR data is changed in the recipe editing tool 1720, the client device may transmit information related to the changed element to the server 2000.

The server 2000 according to an embodiment of the disclosure may receive, from the client device 3000, elements of the MRR data which are changed by the user, and may generate MRR data regarding a new recipe personalized to the user. The client device 3000 may display a user interface 1750 for sharing the generated new recipe of the user. The user may share the new recipe generated by the user with other users, by using the user interface 1750 for sharing the new recipe.

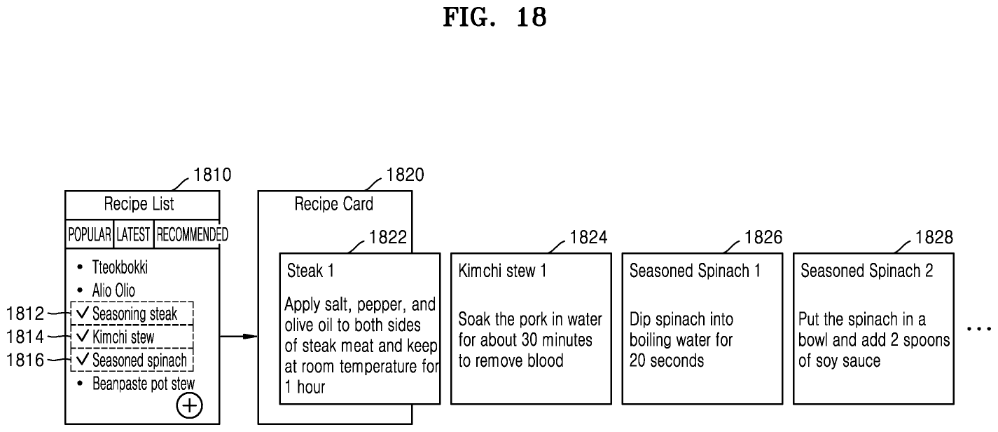

FIG. 18 is a diagram for describing an example where recipe cards for cooking a plurality of foods are provided to a user through a client device, in a cooking information providing system, according to an embodiment of the disclosure.

In FIG. 18, recipe cards may be a first recipe card, and a second recipe card including cooking information personalized to the user. For convenience of explanation, hereinafter, both a first recipe card and a second recipe card are referred to as ‘recipe cards’.

Referring to FIG. 18, a user of a client device according to an embodiment of the disclosure may be a user who wants to cook a plurality of foods in parallel.

In an embodiment of the disclosure, the client device 3000 may display a list 1810 of recipes (hereinafter, referred to as a recipe list) for which MRR data are generated. In order to cook a plurality of foods in parallel, the user of the client device may select recipes for the plurality of foods in the recipe list 1810 displayed on the client device 3000.

In an embodiment of the disclosure, the client device 3000 may receive an input that selects a plurality of recipes in the recipe list 1810 from the user.

For example, the client device 3000 may allow the user to select a seasoning steak recipe 1812, a kimchi stew recipe 1814, or a seasoned spinach recipe 1816 in the recipe list 1810, in order for the user to simultaneously cook a plurality of foods.

The client device 3000 may display recipe cards 1820 corresponding to recipes selected by the user. In this case, in order for the user to cook a plurality of foods in parallel, the client device 3000 may chronologically display the recipe cards 1820 for the plurality of foods based on a time required to cook each food.

For example, the client device 3000 may display a recipe card 1822 corresponding to a first cooking step of the seasoning steak recipe 1812, and may provide cooking information so that the user performs the first cooking step of the seasoning steak recipe 1812.

Next, the client device 3000 may display a recipe card 1824 corresponding to a first cooking step of the kimchi stew recipe 1814, and may provide cooking information so that the user performs the first cooking step of the seasoning steak recipe 1812 and then performs the first cooking step of the kimchi stew recipe 1814.

Next, the client device 3000 may sequentially display a recipe card 1826 corresponding to a first cooking step of the seasoned spinach recipe 1816 and a recipe card 1828 corresponding to a second cooking step of the seasoned spinach recipe 1816, and may provide cooking information so that the user performs the first cooking step of the kimchi stew recipe 1814 and then sequentially performs the first cooking step and the second cooking step of the seasoned spinach recipe 1816.

In the same manner, when the user selects a plurality of recipes to cook a plurality of foods, the client device 3000 may chronologically display the recipe cards 1820 for the plurality of foods based on a time required for cooking, so that the cooking of each food is completed at a similar time.

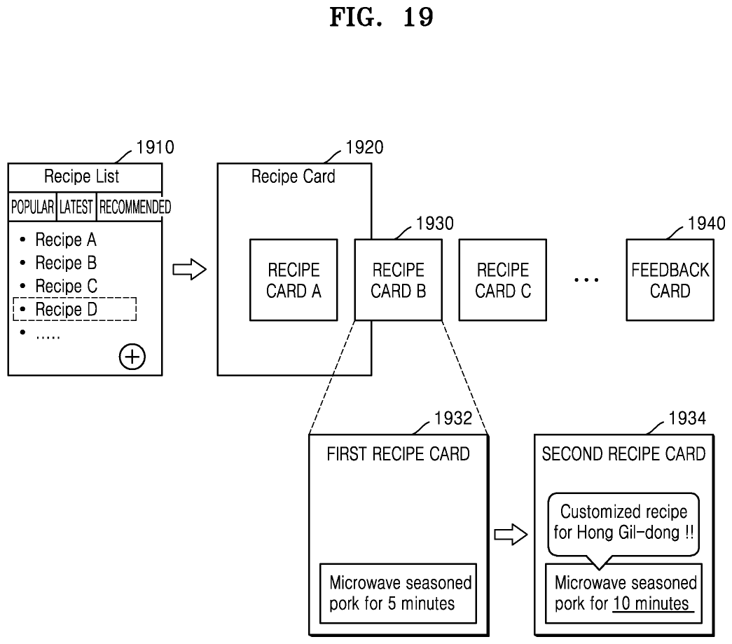

FIG. 19 is a diagram for describing an example where a first recipe card and a personalized second recipe card are provided to a user through a client device, in a cooking information providing system, according to an embodiment of the disclosure.

Referring to FIG. 19, the client device 3000 may display a list 1910 of recipes (hereinafter, referred to as recipe list) for which first MRR data, second MRR data, a first recipe card, and a second recipe card are generated according to the above embodiments of the disclosure.

When the client device 3000 receives an input that selects one recipe in the recipe list 1910 from a user of the client device 3000, the client device 3000 may display recipe cards corresponding to the recipe selected by the user.

For example, when the user of the client device selects ‘recipe D’ in the recipe list 1910, the client device 3000 may display recipe cards 1920 corresponding to the ‘recipe D’.

In this case, each of recipe cards (e.g., a recipe card A, a recipe card B, and a recipe card C) included in the recipe cards 1920 may be a first recipe card or a second recipe card personalized to the user.

For example, in an embodiment of the disclosure, the recipe card B 1930 displayed on the client device 3000 may be a first recipe card 1932 generated by using first MRR data. In his case, in order to provide customized food for the user, the client device 3000 may receive a selection of the user. When the client device 3000 receives an input that requests to display a second recipe card of the user, the client device 3000 may display a second recipe card 1934 generated by using second MRR data.

The server 2000 may receive a cooking device control request according to an input of the user who selects a cooking device control button in the recipe cards from the client device 3000, and may control a cooking device by using cooking device control information included in the MRR data to control the cooking device. In this case, when the input of the user is an input for the first recipe card, the first MRR data may be used, and when the input of the user is an input for the second recipe card, the second MRR data may be used.

After the user receives the first recipe card and the second recipe card and completes cooking, the client device 3000 may display a feedback card 1940 through which the user may input evaluation data related to the completed food. The evaluation data of the user may be transmitted from the client device 3000 to the server 2000, and the server 2000 may generate the second MRR data by using the evaluation data of the user, which has been described with reference to FIG. 10, and thus a description thereof will be omitted.

An information providing method for food cooking according to an embodiment of the disclosure may be embodied as program commands executable by various computer means and may be recorded on a computer-readable recording medium. The computer-readable recording medium may include program commands, data files, data structures, and the like separately or in combinations. The program commands recorded on the computer-readable recording medium may be specially designed and configured for the disclosure or may be well-known to and be usable by one of ordinary skill in the art of computer software. Examples of the computer-readable recording medium include a magnetic medium such as a hard disk, a floppy disk, or a magnetic tape, an optical medium such as a compact disc read-only memory (CD-ROM) or a digital versatile disc (DVD), a magneto-optical medium such as a floptical disk, and a hardware device specially configured to store and execute program commands such as a read-only memory (ROM), a random-access memory (RAM), or a flash memory. Examples of the program commands include advanced language codes that may be executed by a computer by using an interpreter or the like as well as machine language codes made by a compiler.

Also, a cooking information providing method according to disclosed embodiments of the disclosure may be provided in a computer program product. The computer program product is a product purchasable between a seller and a purchaser.

The computer program product may include a software program and a computer-readable storage medium in which the software program is stored. For example, the computer program product may include a software program-type product (e.g., a downloadable application) electronically distributed through a manufacturer of an electronic device or an electronic market (e.g., Google Play™ store or App Store). For electronic distribution, at least a portion of the software program may be stored in a storage medium or temporarily generated. In this case, the storage medium may be a server of the manufacturer, a server of the electronic market, or a storage medium of a relay server that temporarily stores the software program.

The computer program product may include a storage medium of a server or a storage medium of a client device in a system including the server and the client device. Alternatively, when there is a third device (e.g., a smartphone) communicating with the server or the client device, the computer program product may include a storage medium of the third device. Alternatively, the computer program product may include a software program itself transmitted from the server to the client device or the third device or from the third device to the client device.

In this case, one of the server, the client device, and the third device may execute a method according to disclosed embodiments of the disclosure by executing the computer program product. Alternatively, at least two of the server, the client device, and the third device may execute a method according to disclosed embodiments of the disclosure in a distributed fashion by executing the computer program product.

For example, the server (e.g., a cloud server or an AI server) may execute the computer program product stored in the server, and may control the client device communicating with the server to perform a method according to disclosed embodiments of the disclosure.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

1. A method performed by a server for generating data for cooking food, the method comprising:
obtaining text indicating a food recipe;
applying the text to each of a plurality of natural language understanding (NLU) models for analyzing the text;
identifying a plurality of semantic elements included in the text based on at least one semantic element that is output from each of the plurality of NLU models;
generating first machine readable recipe (MRR) data structured to include a plurality of cooking device control parameters, by using the plurality of semantic elements;
obtaining log data of a user related to a device control action performed by the user to operate a cooking device; and
generating second MRR data personalized to the user, by updating the plurality of cooking device control parameters, based on the log data.

2. The method of claim 1, wherein the generating of the second MRR data comprises:
providing, to the cooking device, control information for controlling the cooking device based on the first MRR data;
obtaining compensation values for control operations of the cooking device corresponding to the control information; and
generating the second MRR data by updating the plurality of cooking device control parameters based on an accumulated sum of the compensation values,
wherein the compensation values are determined based on the log data of the user.

3. The method of claim 2, wherein the generating of the second MRR data comprises:
while the cooking device operates according to the control information for controlling the cooking device, receiving, from the cooking device, input data indicating the device control action of the user;
obtaining evaluation data of the user on the food cooked by an operation of the cooking device; and
allocating the received input data of the user and the evaluation data of the user to the compensation values.

4. The method of claim 1, further comprising:
generating a plurality of first recipe cards for cooking the food by using the first MRR data; and
providing the plurality of first recipe cards to a client device.

5. The method of claim 4, further comprising:
generating a plurality of second recipe cards for cooking the food personalized to the user by using the second MRR data; and
providing the plurality of second recipe cards to the client device.

6. The method of claim 4, further comprising determining cooking steps for cooking the food by using the plurality of semantic elements,
wherein the generating of the plurality of first recipe cards comprises determining a type of the plurality of first recipe cards, based on the first MRR data and the determined cooking steps, and
wherein the type of the plurality of first recipe cards comprises at least one of a cooking device control type, a cooking item purchase type, or a cooking information provision type.

7. The method of claim 1, further comprising:
changing at least part of the first MRR data and the second MRR data, so that the food is cooked by another cooking device, based on identification information of the other cooking device.

8. A server for generating data for cooking food, the server comprising:
a communication interface;
a memory storing one or more instructions; and
a processor configured to execute the one or more instructions stored in the memory to:
obtain text indicating a food recipe,
apply the text to each of a plurality of natural language understanding (NLU) models for analyzing the text,
identify a plurality of semantic elements included in the text, based on at least one semantic element that is output from each of the plurality of NLU models,
generate first machine readable recipe (MRR) data structured to include a plurality of cooking device control parameters, by using the plurality of semantic elements,
obtain log data of a user related to device control action performed by the user to operate a cooking device, and
generate second MRR data personalized to the user by updating the plurality of cooking device control parameters, based on the log data.

9. The server of claim 8, wherein the processor is further configured to execute the one or more instructions to:
provide, to the cooking device, control information for controlling the cooking device based on the first MRR data,
obtain compensation values for control operations of the cooking device corresponding to the control information, and
generate the second MRR data by updating the plurality of cooking device control parameters based on an accumulated sum of the compensation values, and
wherein the compensation values are determined based on the log data of the user.

10. The server of claim 9, wherein the processor is further configured to execute the one or more instructions to:
while the cooking device operates according to the control information for controlling the cooking device, receive, from the cooking device, input data indicating the device control action of the user,
obtain evaluation data of the user on the food cooked by an operation of the cooking device, and
allocate the received input data of the user and the evaluation data of the user to the compensation values.

11. The server of claim 8, wherein the processor is further configured to execute the one or more instructions to:
generate a plurality of first recipe cards for cooking the food by using the first MRR data, and
provide the plurality of first recipe cards to a client device.

12. The server of claim 11, wherein the processor is further configured to execute the one or more instructions to:
generate a plurality of second recipe cards for cooking the food personalized to the user by using the generated second MRR data, and
provide the plurality of second recipe cards to the client device.

13. The server of claim 11, wherein the processor is further configured to execute the one or more instructions to:
determine cooking steps for cooking the food by using the plurality of semantic elements, and
determine a type of the plurality of first recipe cards, based on the first MRR data and the cooking steps, and
wherein the type of the plurality of first recipe cards comprises at least one of a cooking device control type, a cooking item purchase type, or a cooking information provision type.

14. The server of claim 8, wherein the processor is further configured to execute the one or more instructions to change at least part of the first MRR data and the second MRR data, so that the food is cooked by another cooking device, based on identification information of the other cooking device.

15. A non-transitory computer-readable recording medium having recorded thereon a program for executing a method for generating data for cooking food, the method comprising:
obtaining text indicating a food recipe;
applying the text to each of a plurality of natural language understanding (NLU) models for analyzing the text;
identifying a plurality of semantic elements included in the text based on at least one semantic element that is output from each of the plurality of NLU models;
generating first machine readable recipe (MRR) data structured to include a plurality of cooking device control parameters, by using the plurality of semantic elements;
obtaining log data of a user related to a device control action performed by the user to operate a cooking device; and
generating second MRR data personalized to the user, by updating the plurality of cooking device control parameters, based on the log data.
